(19) United States
(12) Patent Application Publication
(10) Pub. No.: US 2013/0311694 A1
(43) Pub. Date: Nov. 21, 2013

(54) DEVICES AND METHODS FOR FACILITATING DIRECT PAIRING IN A WIRELESS DOCKING SYSTEM

(71) Applicant: QUALCOMM INCORPORATED, San Diego, CA (US)

(72) Inventors: Phanikumar K. Bhamidipati, San Diego, CA (US); Xiaolong Huang, San Diego, CA (US)

(73) Assignee: QUALCOMM Incorporated, San Diego, CA (US)

(21) Appl. No.: 13/804,409

(22) Filed: Mar. 14, 2013

Related U.S. Application Data
(63) Continuation-in-part of application No. 13/740,466, filed on Jan. 14, 2013.
(60) Provisional application No. 61/756,833, filed on Jan. 25, 2013.
(60) Provisional application No. 61/649,863, filed on May 21, 2012.
(60) Provisional application No. 61/651,991, filed on May 25, 2012.
(60) Provisional application No. 61/658,352, filed on Jun. 11, 2012.
(60) Provisional application No. 61/658,363, filed on Jun. 11, 2012.

(51) Int. Cl. G06F 1/16

(52) U.S. Cl. CPC G06F 1/1632
USPC 710/303

(57) ABSTRACT

Various aspects of the present disclosure enable a docking procedure where a dockee, when docking with a docking host that manages a docking environment, can become directly paired with the peripherals in the docking environment in a straightforward fashion. According to one example, a dockee may transmit a peripheral direct connect request to a docking host. In response, the docking host can send a peripheral direct pair request to the peripheral and a peripheral direct connect response to the dockee, where each message includes respective information to enable the direct pairing between the dockee and the peripheral. Other aspects, embodiments, and features are also included.

### CROSS-REFERENCE TO RELATED APPLICATIONS

The present application for patent claims priority to and the benefit of Provisional Application No. 61/756,833 entitled “APPARATUS AND METHOD FOR DIRECT PAIRING IN A WIRELESS DOCKING SYSTEM” filed Jan. 25, 2013, and is a continuation-in-part of U.S. patent application Ser. No. 13/740,466 entitled “APPARATUS AND METHOD FOR DIRECT PAIRING IN A WIRELESS DOCKING SYSTEM” filed Jan. 14, 2013, and which claims priority to and the benefit of provisional patent application No. 61/649,863, titled “SYSTEM AND METHOD FOR WIRELESS DOCKING UTILIZING A WIRELESS DOCKING PROFILE” and filed on May 21, 2012; provisional patent application No. 61/651,991, titled “APPARATUS AND METHOD FOR PERSISTENT WIRELESS DOCKING” and filed on May 25, 2012; provisional patent application No. 61/658,352, titled “APPARATUS AND METHOD FOR DIRECT PAIRING IN A WIRELESS DOCKING SYSTEM” and filed on Jun. 11, 2012; and provisional patent application No. 61/658,363, titled “APPARATUS AND METHOD FOR WIRELESS DOCKING UTILIZING A WIRELESS DOCKING PROFILE IN THE PRESENCE OF WIRELESS DOCKING ENVIRONMENTS” and filed on Jun. 11, 2012, each of which is assigned to the assignee hereof and hereby expressly incorporated in its entirety as if fully set forth below for all applicable purposes.

### TECHNICAL FIELD

The following relates generally to wireless docking systems, and more specifically to methods and devices for facilitating direct pairing between a dockee and one or more peripherals in a wireless docking system.

### BACKGROUND

Wireless communications systems are widely deployed to provide various types of communication content such as voice, video, packet data, messaging, broadcast, and so on. These systems may be accessed by various types of devices adapted to facilitate wireless communications, where multiple devices share the available system resources (e.g., time, frequency, and power).

Recent interest has been directed toward WLAN connectivity, where a dockee, e.g., a mobile device such as a cellular telephone, can utilize a WLAN interface (e.g., an IEEE 802.11 “Wi-Fi” interface) to establish wireless communication links with one or more peripheral devices. Here, peripheral devices can be any of numerous types, such as a mouse, keyboard, display, printer, camera, speakers, mass storage devices, media servers, sensors, and many others.

Some such WLAN-enabled devices are configured for direct connectivity between devices, e.g., without the need of an intermediate wireless router or docking host. For example, Wi-Fi Direct is a known standard for direct connectivity between a device such as a mobile phone with peripheral devices.

As the demand for mobile broadband access continues to increase, research and development continue to advance wireless technologies not only to meet the growing demand for mobile broadband access, but to advance and enhance the user experience with mobile communications.

### BRIEF SUMMARY OF SOME EXAMPLES

Various examples and implementations of the present disclosure facilitate direct pairing between a dockee and one or more peripherals in a wireless docking system. According to at least one aspect of the present disclosure, dockees are provided to facilitate direct pairing with one or more peripherals in a wireless docking system. In at least some examples, a dockee may include a communications interface and a storage medium each coupled with a processing circuit. The processing circuit may be adapted to establish a docking session with a docking host, and transmit, via the communication interface, a peripheral direct connect request to the docking host. The processing circuit may receive, via the communication interface, a peripheral direct connect response from the docking host, where the peripheral direct connect response includes information to enable the dockee to directly pair with a peripheral. The processing circuit may further establish a direct communication link with a peripheral in accordance with the received information.

Further aspects of the present disclosure provide methods operational on a dockee and/or dockees including means to perform such methods. One or more examples of such methods may include establishing a docking session with a docking host. A peripheral direct connect request may be sent to the docking host. Further, a peripheral direct connect response may be received from the docking host, where the peripheral direct connect response includes information to enable the dockee to directly pair with a peripheral. A direct communication link may be established with a peripheral in accordance with the received information.

Still further aspects include computer-readable storage mediums comprising programming operational on a computer, such as a dockee. According to one or more examples, such programming may be adapted for causing a computer to establish a docking session with a docking host. The programming may also be adapted to cause a computer to transmit a peripheral direct connect request to the docking host, and receive a peripheral direct connect response from the docking host, where the peripheral direct connect response includes information to enable the dockee to directly pair with a peripheral. The programming may further be adapted to cause a computer to establish a direct communication link with a peripheral in accordance with the received information.

According to at least one other aspect of the present disclosure, docking hosts are provided to facilitate direct pairing between a dockee and one or more peripherals in a wireless docking system. In at least some examples, a docking host may include a communications interface and a storage medium each coupled with a processing circuit. The processing circuit may be adapted to pair with a peripheral, and establish a docking session with a dockee. The processing circuit may receive, via the communication interface, a peripheral direct connect request from the dockee to directly pair with the peripheral. Further, the processing circuit may transmit, via the communication interface, a peripheral direct connect response to the dockee, where the peripheral direct connect response includes information to enable the dockee to directly pair with the peripheral.

Further aspects of the present disclosure provide methods operational on a docking host and/or docking hosts including means to perform such methods. One or more examples of such methods may include pairing with a peripheral. A docking session may also be established with a dockee. A peripheral direct connect request may be received from the dockee to directly pair with the peripheral, and a peripheral direct connect response may be sent to the dockee. The peripheral direct connect response may include information to enable the dockee to establish a direct communication link with the peripheral.

Yet additional aspects of the present disclosure include computer-readable storage mediums comprising programming operational on a computer, such as a docking host. According to one or more examples, such programming may be adapted for causing a computer to pair with a peripheral, and establish a docking session with a dockee. The programming may further be adapted to cause a computer to receive a peripheral direct connect request from the dockee to directly pair with the peripheral, and send a peripheral direct connect response to the dockee, wherein the response includes information to enable the dockee to establish a direct communication link with the peripheral.

According to yet another aspect of the present disclosure, peripherals are provided to facilitate direct pairing between a dockee and the peripheral in a wireless docking system. In at least some examples, a peripheral may include a communications interface and a storage medium each coupled with a processing circuit. The processing circuit may be adapted to pair with a docking host. The processing circuit may receive a peripheral direct pairing request from the docking host, where the peripheral direct pairing request includes information to enable direct pairing with a dockee. The processing circuit may further establish a direct communication link with the dockee in accordance with the received information.

Further aspects of the present disclosure provide methods operational on a peripheral and/or peripherals including means to perform such methods. One or more examples of such methods may include pairing with a docking host, receiving a peripheral direct pairing request from the docking host, wherein the peripheral direct pairing request includes information to enable direct pairing with a dockee, and establishing a direct communication link with the dockee in accordance with the received information.

Yet additional aspects of the present disclosure include computer-readable storage mediums comprising programming operational on a computer, such as a peripheral. According to one or more examples, such programming may be adapted for causing a computer to pair with a docking host, and receive a peripheral direct pairing request from the docking host. The peripheral direct pairing request may include information to enable direct pairing with a dockee. The programming may also be adapted to cause a computer to establish a direct communication link with the dockee in accordance with the received information.

Other aspects, features, and embodiments associated with the present disclosure will become apparent to those of ordinary skill in the art upon reviewing the following description in conjunction with the accompanying figures.

### DRAWINGS

FIG. 1 is a simplified schematic diagram of a wireless docking system utilizing a docking environment according to one example.

FIG. 2 is a simplified schematic diagram of a wireless docking system with direct pairing according to one example.

FIG. 3 is a block diagram illustrating an example of a hardware implementation for an apparatus employing a processing system.

FIG. 4 is a simplified block diagram illustrating select components of a peripheral, a docking host, and a dockee according to at least one example, and various communication links as they may appear in a direct pairing system according to one example.

FIG. 5 is a call flow diagram illustrating direct pairing between a dockee and a peripheral according to at least one example in which the docking host is the P2P group owner.

FIG. 6 is a call flow diagram illustrating direct pairing between a dockee and a peripheral according to at least one example in which the dockee is the P2P group owner.

FIG. 7 is a call flow diagram illustrating direct pairing between a dockee and a peripheral according to at least one other example in which the dockee is the P2P group owner.

FIG. 8 is a table depicting each message type and message type ID of a docking protocol according to at least one example.

FIG. 9 is a table depicting an example of at least some fields of a Peripheral Direct Connect Request message are shown according to at least one implementation.

FIG. 10 is a table depicting direct pairing method types according to at least one example.

FIG. 11 is a table showing fields of an operation channel table according to at least one example.

FIG. 12 is a plain text example of a Simple Object Access Protocol (SOAP) body of a Peripheral Direct Connect Request message according to at least one implementation.

FIG. 13 is a plain text example of a directPairingMethodType that may be employed for the directPairingMethod element in the example of FIG. 12.

FIG. 14 is a plain text example of a operatingChannel that may be employed for the operatingChannelInfo element in the example of FIG. 12.

FIG. 15 is an example of at least some fields of a Peripheral Direct Connect Response message according to at least one implementation.

FIG. 16 is a plain text example of a SOAP body of a Peripheral Direct Connect Response message according to at least one implementation.

FIG. 17 is an example of at least some fields of a Peripheral Direct Connect Complete message according to at least one implementation.

FIG. 18 is a SOAP body of a Peripheral Direct Connect Complete message according to at least one implementation.

FIG. 19 is an example of at least some of the fields of a Peripheral Direct Release Notification message according to at least one implementation.

FIG. 20 is a SOAP body of a Peripheral Direct Release Notification message according to at least one example.

FIG. 21 is an example of at least some of the fields of a Peripheral Direct Release Request message according to at least one implementation.

FIG. 22 is a SOAP body of a Peripheral Direct Release Request message according to at least one example.

FIG. 23 is an example of at least some of the fields of a Peripheral Direct Release Response message according to at least one implementation.

FIG. 24 is a SOAP body of a Peripheral Direct Release Response message according to at least one example.

FIG. 25 is an example of at least some fields of a Peripheral Direct Pairing Request message are shown according to at least one implementation.

FIG. 26 is a SOAP body of a Peripheral Direct Pairing Request message according to at least one implementation.

FIG. 27, an example of at least some fields of a Peripheral Direct Pairing Response message are shown according to at least one implementation.

FIG. 28 is a SOAP body of a Peripheral Direct Pairing Response message according to at least one implementation.

FIG. 29 is a flow diagram illustrating at least one example of a method operational on a dockee.

FIG. 30 is a flow diagram illustrating at least one example of a method operational on a docking host.

FIG. 31 is a flow diagram illustrating at least one example of a method operational on a peripheral.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

One or more aspects of the disclosure relate to wireless docking systems. A wireless docking system can provide seamless connectivity, enabling a portable device such as a mobile handset, PDA, tablet computer, etc. to connect with a group of peripheral devices without needing wires or a docking connector, a PIN code or elaborate pairing process for between the dockee and each individual peripheral. The peripherals in any docking environment may act as a group, which needs only to be set up once. Many different types of peripherals may be supported in a docking environment, including the bridging of legacy peripherals. Ideally, the best link, protocol, and QoS would be automatically set up for each type of peripheral connection. The best connection may be selected depending on the application (e.g., for a productivity application, for watching videos, or for playing games, etc.), and the environment (e.g., the home enterprise, internet café, etc.). Here, existing application sessions/connections may be left intact.

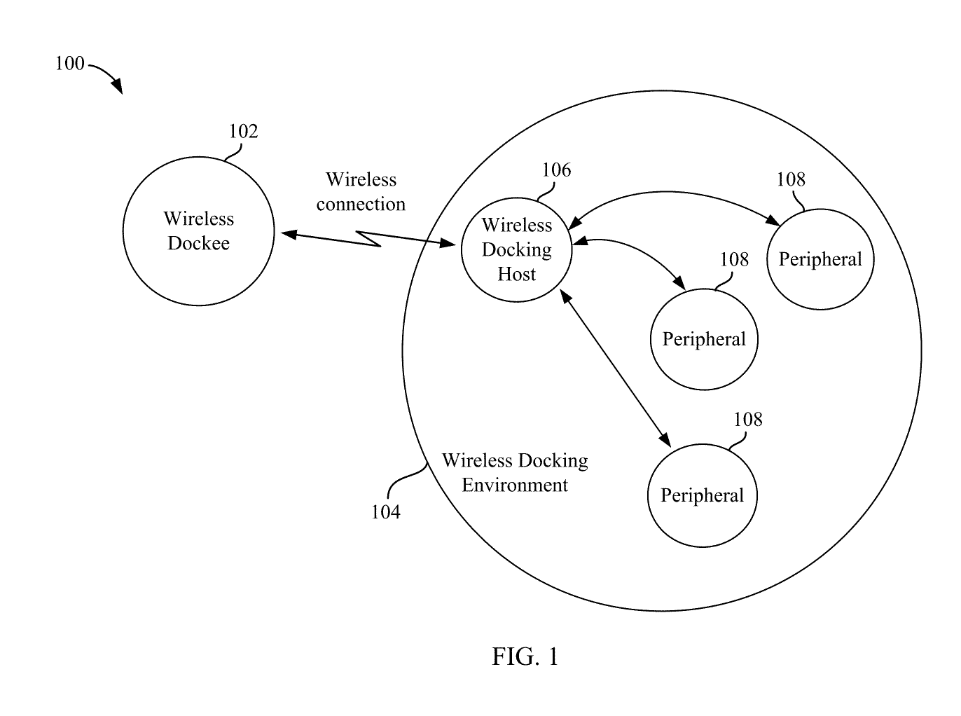

Referring now to FIG. 1, a block diagram of a network environment in which one or more aspects of the present disclosure may find application is illustrated. The wireless docking system 100 is adapted to facilitate seamless connectivity between a wireless dockee 102 and a wireless docking environment 104, where the wireless docking environment includes a wireless docking host 106, and peripherals 108.

The wireless dockee 102 may be any suitable device capable of wirelessly connecting to the wireless docking environment 104 utilizing any suitable communication protocol, which may include but is not limited to IEEE 802.11 “Wi-Fi.” By connecting to the wireless docking environment 104, the dockee 102 may be capable of connecting directly or indirectly to each of the peripherals 108 that are part of the wireless docking environment 104.

The wireless docking environment 104 is a group of one or more physical devices, including one or more wireless docking hosts 106 and one or more peripherals 108. A wireless docking environment 104 can take any suitable configuration or topology, for example, including nothing more than a wireless docking host 106, or additionally including one or more peripherals 108.

The peripherals 108 may represent peripheral functions, e.g., logical functions such as physical display output, keyboard input, etc. In general, a peripheral function may be any I/O function implemented in a wireless docking host 106 that can be made available to a wireless dockee 102 through any of various suitable wireless interfaces; any I/O function in an external peripheral device that can be made available to the wireless dockee 102 through the wireless docking host 106, where the external peripheral device may be directly connected to the wireless docking host 106; or any I/O function in an external peripheral device that can be connected directly to the wireless dockee 102, and whose connection to the wireless dockee 102 is set up utilizing information provided by the wireless docking host 106.

Peripherals 108 may in some examples be embodied as physical devices having wired and/or wireless interfaces for communicating with the wireless dockee 102 through the wireless docking host 106. Some non-limiting examples of peripherals might include LCD monitors or other display devices, speakers, microphones, a keyboard, a mouse, a printer, a scanner, a camera, a mass storage device, etc. The peripherals may be connected with the wireless docking host 106 utilizing any suitable wired or wireless interface, such as USB, Ethernet ports for coupling to a network, or any other suitable device.

The wireless docking host 106 may be any suitable device capable of connecting to the wireless dockee 102 and one or more peripherals 108. For example, a wireless docking host 106 may make available to a wireless dockee 102 peripheral functions on external peripherals 104 that are connected to the docking host 106 directly, as well as peripheral functions the wireless docking host 106 itself may implement (e.g., a display).

In some instances, a wireless dockee 102 may encounter certain inefficiencies when connected with a wireless docking system 100 utilizing the docking host 106 to maintain the docking session between the dockee 102 and the peripherals 108. For example, due to the interposition of the docking host 106 between the dockee 102 and the peripherals 108, there can be an increase in latency added by processing and communication at the docking host 106. Furthermore, it may be the case that the docking host 106 is managing docking sessions for large numbers of dockees 102, which can ultimately overload the processing and/or communication capabilities of the docking host 106.

In some instances, one or more of the peripherals 108 may be enabled for direct communication. For example, in a wireless docking environment 104 facilitating wireless communication over a local area network, e.g., utilizing 802.11 standards such as those using so-called “Wi-Fi,” one or more peripherals 108 may be configured for direct communication with a dockee 102. One example of such direct communication between a dockee 102 and a peripheral without the use of a LAN access point (e.g., without the use of the docking host 106) is frequently referred to as Wi-Fi Direct. Wi-Fi Direct is a standard that enables such wireless devices to communicate directly with one another, without requiring an intermediate wireless access point. In accordance with various aspects of the present disclosure, wireless LAN communication may utilize the Wi-Fi standard, the Wi-Fi Direct standard, or any other suitable standard for wireless communication over a LAN.

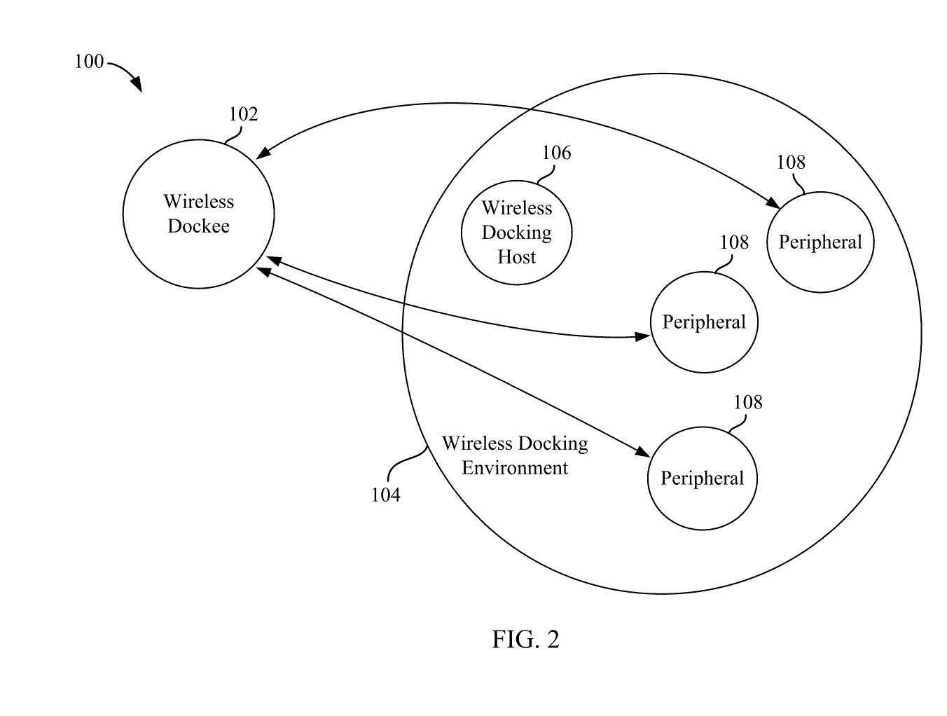

In this scenario, when a wireless dockee 102 docks with a docking host 106 to utilize the docking environment 104 including a peripheral 108 enabled for direct communication, it may be desired for the dockee 102 to become directly paired with that peripheral 108. Once a direct pairing occurs, the dockee 102 may utilize that peripheral 104 without the interposition of the docking host 108 relaying its traffic. Therefore, in accordance with an aspect of the present disclosure, the wireless docking system 100 may be adapted to facilitate a direct pairing between the dockee 102 and one or more peripherals 108. For example, FIG. 2 is a simplified illustration showing a direct pairing between the dockee 102 and various peripherals 108. In FIG. 2, as compared to FIG. 1, a direct wireless connection is shown to be established between the wireless dockee 102 and each of the peripherals 108 in the docking environment 104.

To enable the direct pairing between the wireless dockee 102 and the one or more peripherals 108, it may be desirable to simplify a transition from the existence of the conventional docking environment (as in FIG. 1) to a direct pairing between the dockee 102 and one or more peripherals 108 in the docking environment (as in FIG. 2). To establish this direct pairing, it may further be desired not to require manual operation on the part of the dockee 102 or its user, e.g., typing in a personal identification number (PIN) or password phrase, touching a “pair” button at the dockee 102 and the peripheral 108, etc. That is, if manual operations were required for the pairing between the dockee 102 and the peripheral 108, the docking environment does not serve any purpose in assisting the direct pairing and conventional pairing procedures may be utilized. On the other hand, since it is known that the docking host 106 is already configured with information corresponding to the peripheral 108 by virtue of its pairing and utilization in the docking environment 104, a handing over of the peripheral 108 to the dockee 102 for a direct pairing may be enabled.

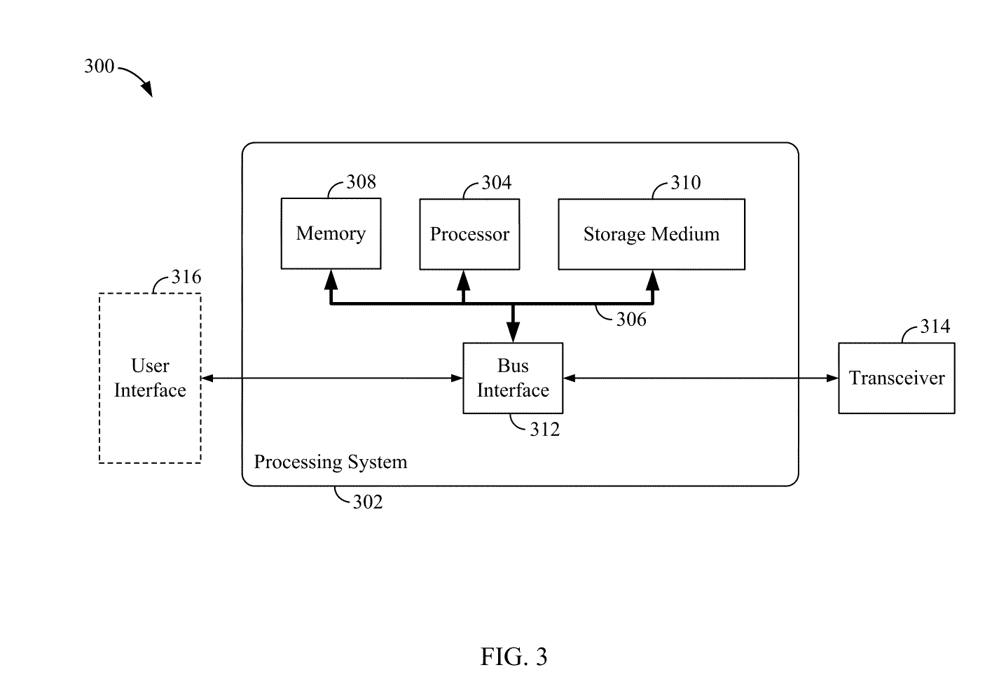

Turning to FIG. 3, a conceptual diagram is depicted illustrating an example of a hardware implementation for an apparatus 300 employing a processing system 302. In accordance with various aspects of the present disclosure, an element, or any portion of an element, or any combination of elements may be implemented with a processing system 302 that includes one or more processors 304. For example, in various aspects, the apparatus 300 may represent any one or more of a wireless dockee, a wireless docking host, and/or a peripheral device.

The processor 304 is arranged to obtain, process and/or send data, control data access and storage, issue commands, and control other desired operations. The processor 304 may include circuitry adapted to implement desired programming provided by appropriate media in at least one example. For example, the processor 304 may be implemented as one or more processors, one or more controllers, and/or other structure configured to execute executable programming. Examples of the processor 304 may include a general purpose processor, a digital signal processor (DSP), an application specific integrated circuit (ASIC), a field programmable gate array (FPGA), a programmable logic device (PLD), or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processor 304 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processor 304 are for illustration and other suitable configurations within the scope of the present disclosure are also contemplated.

In this example, the processing system 302 may be implemented with a bus architecture, represented generally by the bus 306. The bus 306 may include any number of interconnecting buses and bridges depending on the specific application of the processing system 302 and the overall design constraints. The bus 306 links together various circuits including one or more processors (represented generally by the processor 304), a memory 308, and storage media (represented generally by the storage medium 310). The bus 306 may also link various other circuits such as timing sources, peripherals, voltage regulators, and power management circuits, which are well known in the art, and therefore, will not be described any further. A bus interface 312 provides an interface between the bus 306 and a transceiver 314. The transceiver 314 provides a means for communicating with various other apparatus over a transmission medium. Depending upon the nature of the apparatus, a user interface 316 (e.g., keypad, display, speaker, microphone, joystick) may also be provided.

The processor 304 is adapted for managing the bus 306 and general processing, including the execution of programming, which may be stored on the storage medium 310. The programming, when executed by the processor 304, causes the processing system 302 to perform the various functions described infra for any particular apparatus. The storage medium 310 may also be used for storing data that is manipulated by the processor 304 when executing programming. As used herein, the term “programming” shall be construed broadly to include without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The storage medium 310 may represent one or more computer-readable, machine-readable, and/or processor-readable devices for storing programming, such as processor executable code or instructions (e.g., software, firmware), electronic data, databases, or other digital information. The storage medium 310 may also be used for storing data that is manipulated by the processor 304 when executing programming. The storage medium 310 may be any available media that can be accessed by a general purpose or special purpose processor, including portable or fixed storage devices, optical storage devices, and various other mediums capable of storing, containing and/or carrying programming. By way of example and not limitation, the storage medium 310 may include a computer-readable, machine-readable, and/or processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof.

The storage medium 310 may be coupled to the processor 304 such that the processor 304 can read information from, and write information to, the storage medium 310. That is, the storage medium 310 can be coupled to the processor 304 so that the storage medium 310 is at least accessible by the processor 304, including examples where the storage medium 310 is integral to the processor 304 and/or examples where the storage medium 310 is separate from the processor 304 (e.g., resident in the processing system 302, external to the processing system 302, distributed across multiple entities). In some examples, the storage medium 310 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

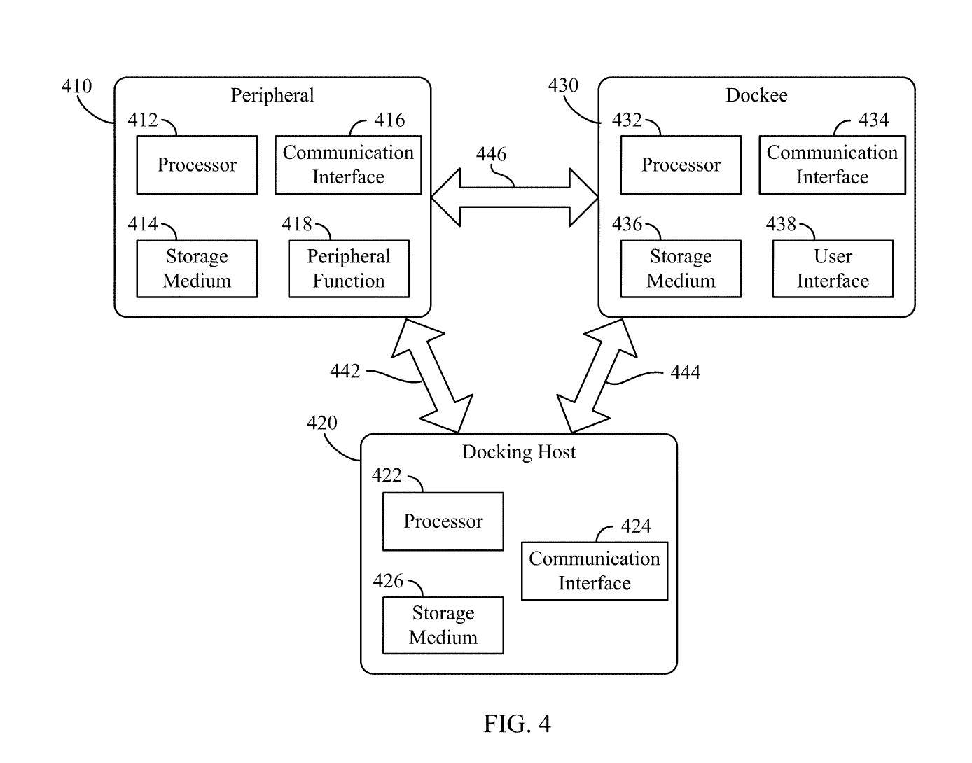

FIG. 4 is a simplified block diagram illustrating select components of a peripheral 410, a docking host 420, and a dockee 430 according to at least one example. In the illustrated example, the peripheral 412 includes at least one processor 412, a storage medium 414 communicatively coupled to the at least one processor 412, a communication interface 416 communicatively coupled to the at least one processor 412, and optional peripheral function circuitry 418. In some aspects of the disclosure, the at least one processor 412 may be the processor 304 included in the processing system 302 described above and illustrated in FIG. 3.

The storage medium 414 may be the storage medium 310 described above with reference to FIG. 3. Programming stored by the storage medium 414, when executed by the processor 412, causes the processor 412 to perform one or more of the various functions and/or process steps described herein for a peripheral. For example, the storage medium 414 may include dockee direct pairing operations adapted to cause the processor 412 to establish a direct communication link with a dockee, as described herein. Thus, according to one or more aspects of the present disclosure, the processor 412 is adapted to perform (in conjunction with the storage medium 414) any or all of the processes, functions, steps and/or routines for any or all of the peripherals described herein (e.g., peripheral 108, access terminal 410). As used herein, the term “adapted” in relation to the processor 412 may refer to the processor 412 being one or more of configured, employed, implemented, and/or programmed (in conjunction with the storage medium 414) to perform a particular process, function, step and/or routine according to various features described herein.

In various aspects of the disclosure, the communication interface 416 may be a wireless interface configured for communication with a docking host 420. For example, the communication interface 416 may include a Wi-Fi interface compatible with any of the family of standards defined under the IEEE 802.11 standards, an IEEE 802.15.1 “Bluetooth” interface, an IEEE 802.15.4 “ZigBee” interface, or any other suitable wireless communication interface. Of course, some examples of a peripheral 410 may include two or more of the above-described or other communication interfaces. In a particular example described in further detail below, the communication interface 416 may be configured to be compatible with Wi-Fi Direct protocols. Further, when included in a peripheral 410, the peripheral function circuitry 418 may be embodied in any number of ways, including for example a user interface, a display, microphone, speaker, network interface, etc.

Further, in the illustrated example of FIG. 4, the docking host 420 includes at least one processor 422, a communication interface 424 communicatively coupled to the at least one processor 422, and a storage medium 426 communicatively coupled to the at least one processor 422. In some aspects of the disclosure, the at least one processor 422 may be the processor 304 included in the processing system 302 described above with reference to FIG. 3.

The storage medium 426 may be the storage medium 310 described above with reference to FIG. 3. Programming stored by the storage medium 426, when executed by the processor 422, causes the processor 422 to perform one or more of the various functions and/or process steps described herein for a peripheral. For example, the storage medium 426 may include docking host pairing operations adapted to cause the processor 422 to facilitate establishment of a direct communication link between a dockee 430 and a peripheral 410, as described herein. Thus, according to one or more aspects of the present disclosure, the processor 422 is adapted to perform (in conjunction with the storage medium 426) any or all of the processes, functions, steps and/or routines for any or all of the docking hosts described herein (e.g., docking host 106, docking host 420). As used herein, the term “adapted” in relation to the processor 422 may refer to the processor 422 being one or more of configured, employed, implemented, and/or programmed (in conjunction with the storage medium 426) to perform a particular process, function, step and/or routine according to various features described herein.

In various aspects of the disclosure, the communication interface 424 may include a Wi-Fi interface compatible with any of the family of standards defined under the IEEE 802.11 standards, an IEEE 802.15.1 “Bluetooth” interface, an IEEE 802.15.4 “ZigBee” interface, or any other suitable wireless communication interface. Of course, some examples of a docking host 420 may include two or more of the above-described or other communication interfaces. In a particular example described in further detail below, the communication interface 424 may be configured to be compatible with Wi-Fi Direct protocols.

Still further, in the illustrated example of FIG. 4, the dockee 430 includes at least one processor 432, a communication interface 434 communicatively coupled to the at least one processor 432, a storage medium 436 communicatively coupled to the at least one processor 432, and a user interface 438 communicatively coupled to the at least one processor 432. In some aspects of the disclosure, the at least one processor 432 may be the processor 304 included in the processing system 302 described above with reference to FIG. 3.

The storage medium 436 may be the storage medium 310 described above with reference to FIG. 3. Programming stored by the storage medium 436, when executed by the processor 432, causes the processor 432 to perform one or more of the various functions and/or process steps described herein for a peripheral. For example, the storage medium 436 may include docking host pairing operations adapted to cause the processor 432 to establish a direct communication link with a peripheral 410, as described herein. Thus, according to one or more aspects of the present disclosure, the processor 432 is adapted to perform (in conjunction with the storage medium 436) any or all of the processes, functions, steps and/or routines for any or all of the dockees described herein (e.g., dockee 102, dockee 430). As used herein, the term “adapted” in relation to the processor 432 may refer to the processor 432 being one or more of configured, employed, implemented, and/or programmed (in conjunction with the storage medium 436) to perform a particular process, function, step and/or routine according to various features described herein.

In various aspects of the disclosure, the communication interface 434 may include a Wi-Fi interface compatible with any of the family of standards defined under the IEEE 802.11 standards, an IEEE 802.15.1 “Bluetooth” interface, an IEEE 802.15.4 “ZigBee” interface, or any other suitable wireless communication interface. Of course, some examples of a dockee 430 may include two or more of the above-described or other communication interfaces. In a particular example described in further detail below, the communication interface 434 may be configured to be compatible with Wi-Fi Direct protocols.

In a further aspect of the disclosure, the dockee 430 may include a user interface 438 for input/output functionality enabling communication between a user and the wireless docking system. As an illustrative but non-limiting example, the dockee 430 may be embodied as a smartphone or tablet device, including a touch-screen interface providing user input and output functionality.

Referring still to FIG. 4, the various communication links that may be utilized in various aspects of the disclosure is also illustrated. In general, as described below, the peripheral 410 is paired, or has a first communication link 442 established, with the docking host 420. At this time, the dockee 430 initiates a second communication link 444 with the docking host 420, to establish a docking session including the peripheral 410, e.g., as a part of a docking environment. In an aspect of the disclosure, a direct communication link 446 may be established between the dockee 430 and the peripheral 410, such that the first communication link 442 between the docking host 420 and the peripheral 410 may be severed.

One technology that may enable such a direct communication link 446 between the dockee 430 and the peripheral 410 without the use of a LAN access point such as the docking host 420 is frequently referred to as Wi-Fi Direct. Wi-Fi Direct is an existing, published standard that enables such wireless devices to communicate directly with one another, without requiring an intermediate wireless access point. In accordance with various aspects of the present disclosure, wireless LAN communication may utilize the Wi-Fi standard, the Wi-Fi Direct standard, or any other suitable standard for wireless communication over a LAN. For ease of explanation, in the description that follows, the dockee 430 and the peripheral 410 include a communication interface 434, 416, respectively, configured for communication utilizing the Wi-Fi Direct standard.

Various aspects of the present disclosure provide a dockee 430 with a capability to pair directly with one or more peripherals 410 paired with a docking host 420 within a docking environment (e.g., wireless docking environment 104 in FIGS. 1 and 2). Further aspects of the disclosure provide a persistent direct pairing capability, wherein the dockee 430 may return to the docking host 420 at a later time and the direct docking between the dockee 430 and the one or more peripherals 410 may be efficiently re-established.

Among various possible configurations, below, two potential use cases are discussed. In a first example, the docking host 420 may be configured as a P2P group owner (GO), with the dockee 430 being configured as a P2P client of the docking host 420. In another example, the dockee 430 may be configured as a P2P GO, such that the docking host 420 is a P2P client of the dockee 430.

In an example where the dockee 430 is a client (e.g., a P2P client) of the docking host 420, it is generally the case that one or more peripherals 410 would additionally be P2P clients of the docking host 420. In this case, tunneled direct link setup (TDLS) may be utilized to directly connect the dockee 430 with the one or more peripherals 410. Because TDLS is standardized, such a direct pairing can be simplified. That is, the dockee 430 may initiate the TDLS procedure through the docking host 420, and accordingly, the dockee 430 can directly connect with the one or more peripherals 410.

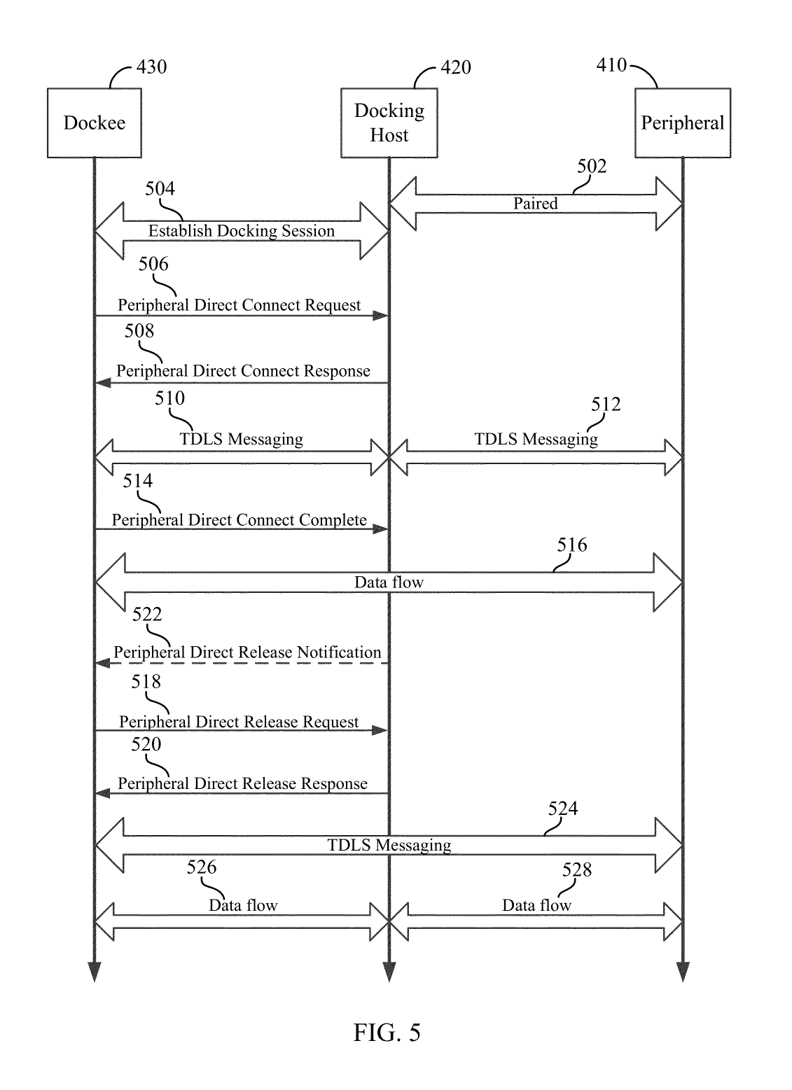

Turning to FIG. 5, a call flow diagram is depicted illustrating direct pairing between a dockee 430 and a peripheral according to at least one example in which the docking host 420 is the P2P group owner. Initially, at 502, the docking host 420 is established as a P2P GO, having the peripheral 410 attached to the docking host 420 as a P2P client.

When in a service discovery phase, the docking host 420 may advertise its peripherals for proximate dockees, and in an aspect of the disclosure, may additionally advertise TDLS as a payload connection option for use by a dockee in a direct pairing session. The dockee 430 may establish a docking session 504 with the docking host 420, joining as a P2P client of the P2P group of which the docking host 420 is the P2P GO. Here, in some aspects of the disclosure, the attachment of the dockee 430 with the docking host 420 may include some manual operation on the part of the user; however, in a further aspect of the disclosure, the handing over of the peripheral(s) 410 to the dockee 430 for direct pairing need not include any further manual pairing operations.

During the docking session 504, the dockee 430 may send a peripheral direct connect request message 506 to the docking host 420 to signal the intent of the dockee 430 to directly connect to a peripheral 410. In this example, the peripheral direct connect request 506 can identify the direct pairing method to be TDLS. That is, the peripheral direct connect request message 506 may include a request to utilize TDLS as its payload connection type to directly communicate with the peripheral(s) 410.

The docking host 420 may respond by sending a peripheral direct connect response message 508 to the dockee 430. On receipt of the response 508 with an acceptance to directly pair, the dockee 430 and the peripheral 410 may each communicate with the docking host 420 using TDLS message transactions 510 and 512 to establish a direct TDLS communication link between the dockee 430 and the peripheral 410 for direct communication.

When the direct communication link is established between the dockee 430 and the peripheral 410, the dockee 430 may send a peripheral direct connect complete message 514 to the docking host 420. The peripheral direct connect complete message 514 may be adapted to indicate to the docking host 420 that the dockee 430 has successfully paired with the peripheral 410. With the direct communication link established between the dockee 430 and the peripheral 410, data may be wirelessly communicated 516 directly between the two devices.

With the dockee 430 directly paired/connected with the peripheral 410, the dockee 430 may decide to end the direct communication link with the peripheral 410. In such instances, the dockee 430 can send a peripheral direct release request message 518 to the docking host 420. The peripheral direct release request message 518 may be adapted to request the docking host 420 to end the direct communication link between the peripheral 410 and the dockee 430, and to reestablish a communication link with the docking host 420. The docking host 420 can respond by sending a peripheral direct release response message 520 to the dockee 430.

In some examples, the docking host 420 may decide to end the direct communication link between the dockee 420 and the peripheral 410. In such examples, the docking host can send a peripheral direct release notification message 522 to the dockee 430. In response to the peripheral direct release notification message 522, the dockee 430 sends the peripheral direct release request message 518 to the docking host 420, followed by a peripheral direct release response message 520 sent from the docking host 420 to the dockee 430.

On receipt of the response 520, the dockee 430 and the peripheral 410 may communicate with each other using TDLS message transactions 524 to end the direct communication link and reestablish a communication link with the docking host 420. After the communication link is reestablished with the docking host 420, the dockee 430 and the peripheral 410 can communicate data 526, 528 via the docking host 420.

Referring now to the second example introduced above, a direct pairing between a dockee 430 and one or more peripherals 410 may be enabled with the dockee 430 as a P2P group owner (GO), and the docking host 420 is a P2P client for the dockee 430. In general, the docking host 420 can assist the peripheral(s) 410 to directly connect to the dockee 430 in various suitable manners. In a first example, the peripheral 410 can connect to the dockee 430 as a P2P client connects to a P2P GO, e.g., by going first through a PIN-based Wi-Fi Simple Configuration (WSC) procedure, wherein the PIN is dynamically generated and given by the docking host 420 to the dockee 430. In a second example, the peripheral 410 may connect to the dockee 430 as a P2P Client connects to a P2P GO, utilizing the P2P Group Credential. Each of these examples is described in further detail below.

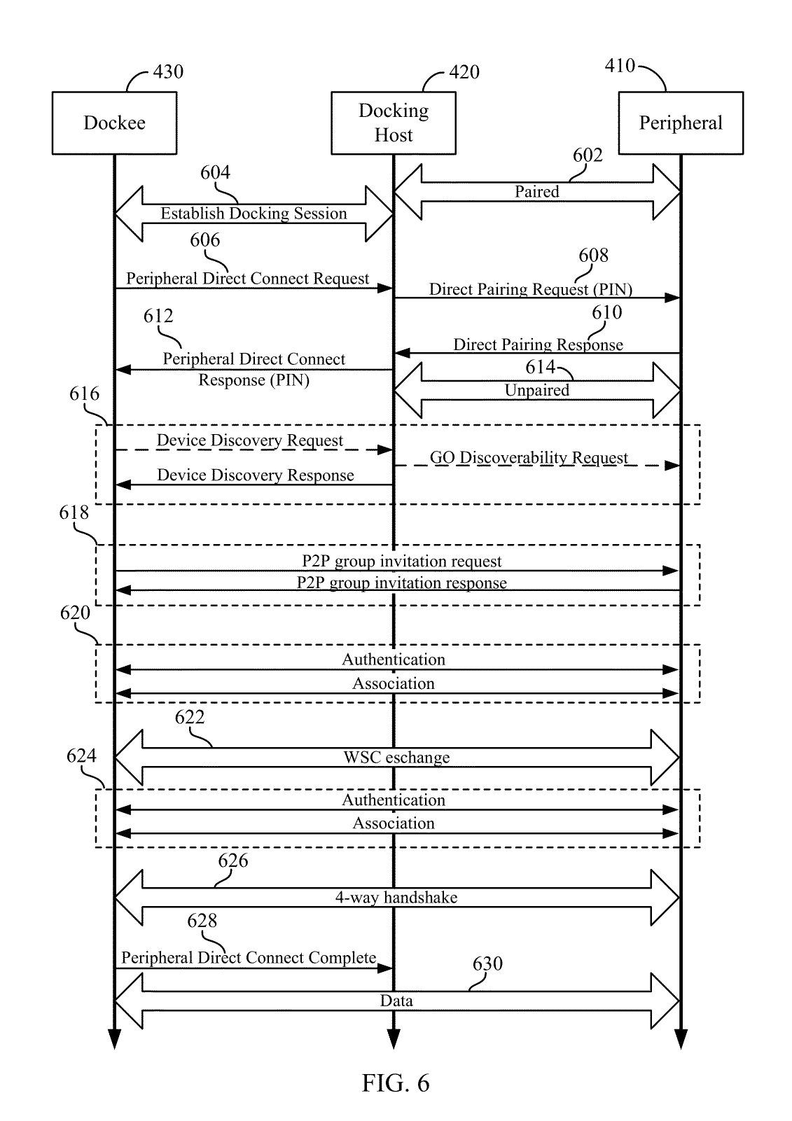

Turning to FIG. 6, a call flow diagram is depicted illustrating direct pairing between a dockee 430 and a peripheral according to at least one example in which the dockee 430 is the P2P group owner. In this example, the peripheral 410 can connect to the dockee 430 using a PIN-based Wi-Fi Simple Configuration (WSC) procedure. Initially, at 602, the peripheral 410 is paired with the docking host 420, and a docking session has been established 604 between the dockee 430 and the docking host 420.

While the dockee 430 and docking host 420 are paired, the dockee 430 may transmit a peripheral direct connect request message 606 to the docking host 420 to indicate its intent to directly pair with the peripheral 410. In this example, the peripheral direct connect request message 606 may be adapted to identify the direct pairing method as P2P with a WSC procedure. Such a peripheral direct connect request message 606 may include information relating to an operating channel to be employed for direct pairing.

In response to the request 606 from the dockee 430, the docking host 420 may transmit a direct pairing request message 608 to the peripheral 410. The direct pairing request message 608 may be adapted to identify the direct pairing method as P2P with a WSC procedure. In the example depicted in FIG. 6, the docking host 420 may dynamically generate a PIN for a WSC procedure for direct pairing between the dockee 430 and the peripheral 410, and may transmit the generated PIN to the peripheral 410 and the dockee 430. Accordingly, the direct pairing request message 608 may include additional information, such as P2P device address of the dockee 430, the PIN to be employed for the WSC procedure between the dockee 430 and the peripheral 410, an optional identification of the operation channel for direct pairing, and an optional expiration time for a direct communication link between the dockee 430 and the peripheral 410.

In response to the direct pairing request 608, the peripheral 410 may transmit a direct pairing response message 610 back to the docking host 420. On receiving the direct pairing response message 610 from the peripheral 410, the docking host 420 can transmit a peripheral direct connect response message 612 to the dockee 430. The peripheral direct connect response 612 can include information such as a P2P device address for the peripheral 410, the PIN to be employed for the WSC procedure between the dockee 430 and the peripheral 410, and the optional expiration time for a direct communication link between the dockee 430 and the peripheral 410.

Following receipt of the peripheral direct connect response 612, the dockee 430 may begin a process to contact with the peripheral 410. Thus, at 616 a device phase may begin. Here, the dockee 430 may request the docking host 420 to make the peripheral 410 discoverable, and then invite the peripheral 410 to join the P2P Group of which the dockee 430 is the GO. For example, the dockee 430 may transmit a device discovery request for the peripheral 410 to the docking host 420; and the docking host 420 may forward the discoverability request as a GO discoverability request to the peripheral 410. This discoverability request may be configured to inform the peripheral 410 about its needed availability on a particular channel used by the dockee 430, or other communication information for use between the dockee 430 and the peripheral 410. The docking host 420 may further transmit a device discovery response for the peripheral 410 to the dockee 430, such that the dockee 430 is configured with information for communicating with the peripheral 410.

Thereafter, at 618 the dockee 430 may configure its communication interface 434 to utilize the configuration information received above so that it may communicate with the peripheral 410, and accordingly transmit a P2P group invitation request directly to the peripheral 410. The peripheral 410 may accordingly respond with a P2P group invitation response to the dockee 430. Next, the dockee 430 and the peripheral 410 may enter into an authentication phase 620.

As illustrated, two authentication phases 620 and 624 are utilized. Here, the first authentication phase 620 may establish a persistent key for implementing a persistent direct pairing between the dockee 430 and the peripheral 410. The second authentication phase 624 may establish a session key for implementing a particular direct pairing session between the dockee 430 and the peripheral 410. The persistent direct pairing and the session are described in further detail below.

That is, the first authentication message 620 may include an authentication request that may specify the dockee 430 or the peripheral 410. The authentication may utilize the identification information (e.g., the PIN) provided to the dockee 430 by the docking host 420 (as described above in with reference to messages 608 and 612 above). Following the first authentication phase 620, provisioning may be implemented utilizing a Wi-Fi Simple Configuration (WSC) exchange 622. At this point, both the dockee 430 and the peripheral 410, will have a persistent key to utilize to communicate with one another. Here, the persistent key may be a different entity than the identification information discussed above, and may be a secret key shared only by the dockee 430 and the peripheral 410. From that time, the dockee 430 and the peripheral 410 may utilize the second authentication message 624, an association message, and a 4-way handshake 626 to establish a session key to be utilized for the current pairing session. Once the session key is established during the 4-way handshake 626 for the current pairing session, data 630 may begin to flow between the dockee 430 and the peripheral 410 in a secure fashion.

At some point after the direct communication link is set up between the dockee 430 and the peripheral 410, the dockee 430 may send a peripheral direct connect complete message 628 to the docking host 420. The peripheral direct connect complete message 628 can be adapted to indicate to the docking host 420 that the dockee 430 has successfully paired directly with the peripheral 410.

Furthermore, with the persistent key established at the first authentication phase 620 described above, a persistent direct pairing session may be established between the dockee 430 and the peripheral 410. That is, the above-described process shown and described in relation to FIG. 6 may be utilized upon an initial pairing of the dockee 430 with the docking environment 104 including the peripheral 410. However, upon subsequent docking sessions between the dockee 430 and the docking host 420 to utilize the peripheral 410, the prior pairing may persist and the subsequent pairing procedure may be simplified.

If the direct pairing request message 608 includes a direct connection expiration time, the peripheral 410 can use a direct connection life timer to monitor the direct connection with the dockee 430, where the expiration time set to the direct connection expiration time. The peripheral 410 can terminate the direct connection with the dockee 430 when the direct connection life timer expires, and can pair back to the docking host 420.

Although not depicted in FIG. 6, the dockee 430 may decide to end the direct communication link with the peripheral 410. Similar to such features described above with reference to FIG. 5, the dockee 430 can send a peripheral direct release request message to the docking host 420, where the peripheral direct release request message is adapted to request that the direct communication link between the peripheral 410 and the dockee 430 be terminated and a communication link with the docking host 420 be reestablished. The docking host 420 can respond by sending a peripheral direct release response message to the dockee 430. In some examples, the docking host 420 may send a peripheral direct release notification message to the dockee 430 to initiate the termination of the direct communication link between the dockee 430 and the peripheral 410.

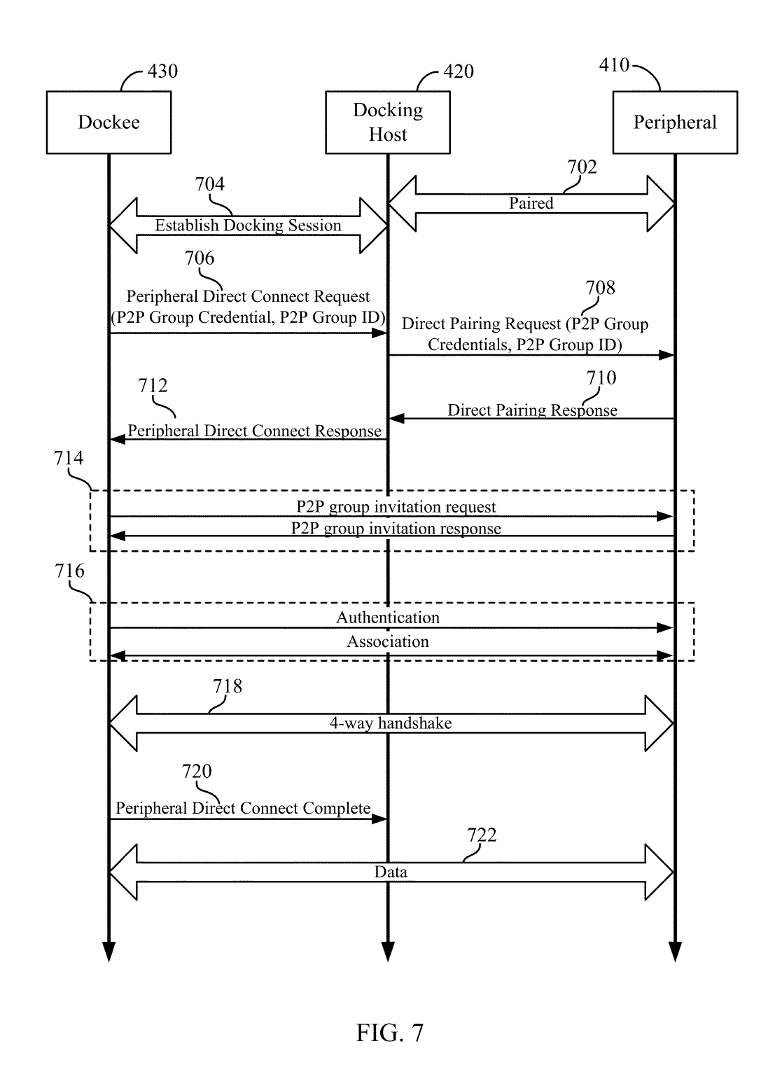

A second example for establishing the direct communication link between the dockee 430 and the peripheral 410 is now described, where the peripheral 410 may connect to the dockee 430 as a P2P client connects to a P2P GO, utilizing a P2P Group Credential forwarded to the peripheral 410 by the docking host 420. FIG. 7 is a call flow diagram illustrating such direct pairing between a dockee 430 and a peripheral 410 according to at least one example in which the dockee 430 is the P2P group owner.

Initially, at 702, the peripheral 410 is paired with the docking host 420, and a docking session has been initiated 704 between the dockee 430 and the docking host 420. In this example, as above, while the peripheral 410 is connected to the docking host 420 as a P2P client, the dockee 430 approaches the docking host 420 and establishes a communication link such that the dockee 230 is a P2P GO.

While the dockee 430 and docking host 420 are paired, the dockee 430 may transmit a peripheral direct connect request message 706 to the docking host 420 to indicate its intent to directly pair with the peripheral 410. In this example, the peripheral direct connect request message 706 may be adapted to identify the direct pairing method as P2P with forwarded credentials. Such a peripheral direct connect request message 706 may include a P2P Group SSID associated with the P2P group of the dockee 430, P2P credentials associated with the P2P group of the dockee 430, and optionally an operation channel for direct pairing.

In response to the peripheral direct connect request message 706, the docking host 420 can forward the P2P group credentials and the P2P group ID to the peripheral 410 in a direct pairing request message 708. The direct pairing request message 708 may also include the P2P device address of the dockee 430, the P2P group operating channel for direct pairing, and an optional expiration time set by the docking host 420 for a direct communication link between the dockee 430 and the peripheral 410.

In response to the direct pairing request 708, the peripheral 410 may transmit a direct pairing response message 710 back to the docking host 420. On receiving the direct pairing response message 710 accepting direct pairing from the peripheral 410, the docking host 420 can transmit a peripheral direct connect response message 712 to the dockee 430. The peripheral direct connect response 712 can include information such as a P2P device address for the peripheral 410, and the optional expiration time for a direct communication link between the dockee 430 and the peripheral 410.

On receipt of the peripheral direct connect response message 712 with an acceptance to pair, the dockee 430 and the peripheral 410 can discover each other in the designated operating channel. After the dockee 430 and the peripheral 410 discover each other, the dockee 430 may, at 714, transmit a P2P group invitation request directly to the peripheral 410. The peripheral 410 may accordingly respond with a P2P group invitation response to the dockee 430.

Next, the dockee 430 and the peripheral 410 may enter into an authentication phase 716. The authentication phase 716 may include an authentication request that may specify the dockee 430 or the peripheral 410. The authentication may utilize the identification information (e.g., the P2P group credentials) provided by the dockee 430 to the peripheral. The dockee 430 and the peripheral 410 may utilize the authentication message phase 716, an association message, and a 4-way handshake 718 to establish a session key to be utilized for the current pairing session. Once the session key is established during the 4-way handshake 718 for the current pairing session, data 722 may begin to flow between the dockee 430 and the peripheral 410 in a secure fashion.

At some point after the direct communication link is set up between the dockee 430 and the peripheral 410, the dockee 430 may send a peripheral direct connect complete message 720 to the docking host 420. The peripheral direct connect complete message 720 can be adapted to indicate to the docking host 420 that the dockee 430 has successfully paired directly with the peripheral 410.

If the direct pairing request message 708 includes a direct connection expiration time, the peripheral 410 can use a direct connection life timer to monitor the direct connection with the dockee 430, where the expiration time set to the direct connection expiration time. The peripheral 410 can terminate the direct connection with the dockee 430 when the direct connection life timer expires, and can pair back to the docking host 420.

Although not depicted in FIG. 7, the dockee 430 may decide to end the direct communication link with the peripheral 410. Similar to such features described above with reference to FIG. 5, the dockee 430 can send a peripheral direct release request message to the docking host 420, where the peripheral direct release request message is adapted to request that the direct communication link between the peripheral 410 and the dockee 430 be terminated and a communication link with the docking host 420 be reestablished. The docking host 420 can respond by sending a peripheral direct release response message to the dockee 430. In some examples, the docking host 420 may send a peripheral direct release notification message to the dockee 430 to initiate the termination of the direct communication link between the dockee 430 and the peripheral 410.

According to an aspect of the present disclosure, at least some of the messaging employed in a wireless docking environment 104 is adapted to facilitate the various pairing methods without different messages for each pairing method. That is, a common messaging format for at least some of the messaging between the dockee 430, the docking host 420 and the peripheral 410 is adapted for use with any of the various pairing methods. In this manner, the messaging can more readily facilitate standardization and universal employment for a plurality of different types of peripherals 410, where any of a plurality of pairing methods may be employed.

As can be seen in the description above, common message-types can be used for each of the various pairing methods. For instance, each of the examples described above with reference to FIGS. 5-7 employ or can employ a peripheral direct connect request message (e.g., messages 506, 606, 706), a peripheral direct connect response message (e.g., messages 508, 612, 712), a peripheral direct connect complete message (e.g., messages 514, 628, 720), a peripheral direct release notification message (e.g., message 522), a peripheral direct release request message (e.g., message 518), and/or a peripheral direct release response message (e.g., message 520). In addition, the examples described above with reference to FIGS. 6 and 7 include direct pair request messages (e.g., messages 608, 708), and/or direct pair response messages (e.g., messages 610, 710). In at least one example of the present disclosure, each of these messages can employ a standard message structure for all of the pairing methods.

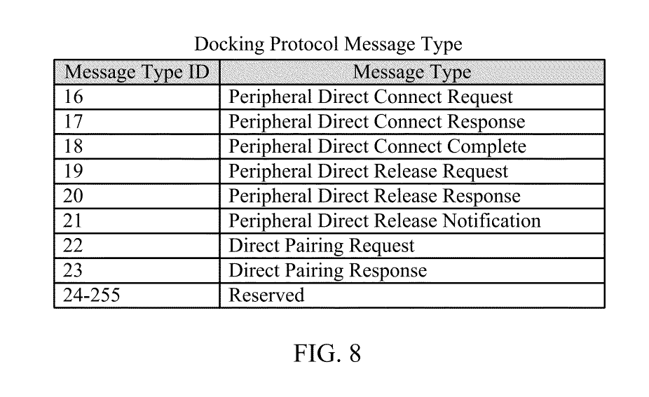

FIG. 8 illustrates a table depicting each message type and message type ID of a docking protocol according to at least one example. As shown, a unique message type ID is provided for peripheral direct connect request messages, peripheral direct connect response messages, peripheral direct connect complete messages, peripheral direct release notification messages, peripheral direct release request messages, peripheral direct release response messages, direct pair request messages, and direct pair response messages.

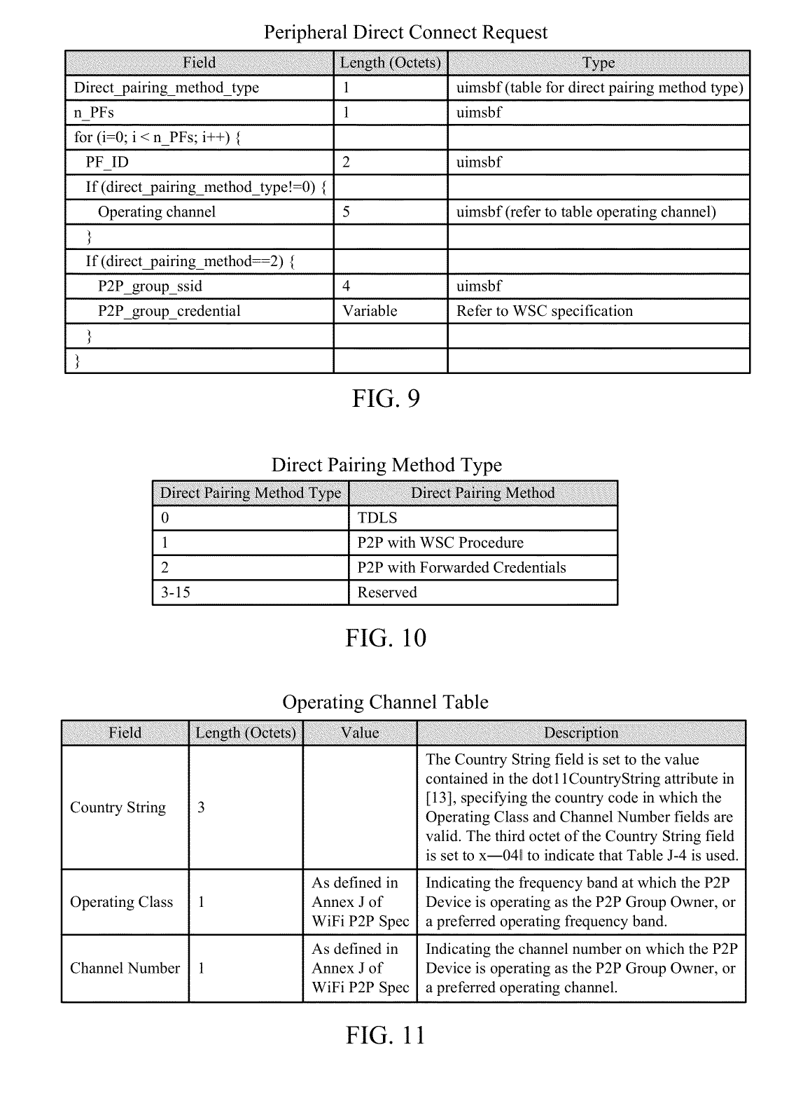

Turning to FIG. 9, an example of at least some fields of a Peripheral Direct Connect Request message are shown according to at least one example. This peripheral direct connect request message can be used for all of the peripheral direct connect request messages 506, 606, and 706 in FIGS. 5-7 above. In this example, the Peripheral Direct Connect Request message includes a directpairing_method_type field. This field can indicate the type of direct pairing method to be used to connect to the peripheral 410. An example of the table referred to is shown in FIG. 10. As shown, the direct pairing methods may include TDLS (e.g., as described above with reference to FIG. 5), P2P with WSC procedure (e.g., as described above with reference to FIG. 6), or P2P with forwarded credentials (e.g., as described above with reference to FIG. 7).

Referring again to FIG. 9, the Peripheral Direct Connect Request message includes an n_PFs field. The n_PFs field can include the number of peripherals hosted by the docking host 420. A PF_ID field can also be included, which is adapted to include the ID of the peripheral 410 to which the dockee 430 is requesting to directly pair. In at least some examples, this ID can be unique for all peripherals 410 associated with the docking host 420, and can be assigned to each peripheral 410 by the docking host 420.

The Peripheral Direct Connect Request message can also include an operating channel field. The operating channel field can include the channel on which the P2P group is or will be operating and may be defined according to a table. An example of a structure of this table is depicted in FIG. 11.

A P2P_group_ssid field may be included, which is adapted to include the SSID used by a P2P group owner (GO) for a P2P group. A P2P_group_credential field may also be included, with information that is required to join a P2P group. An example of such information is defined in the WiFi Simple Configuration specification.

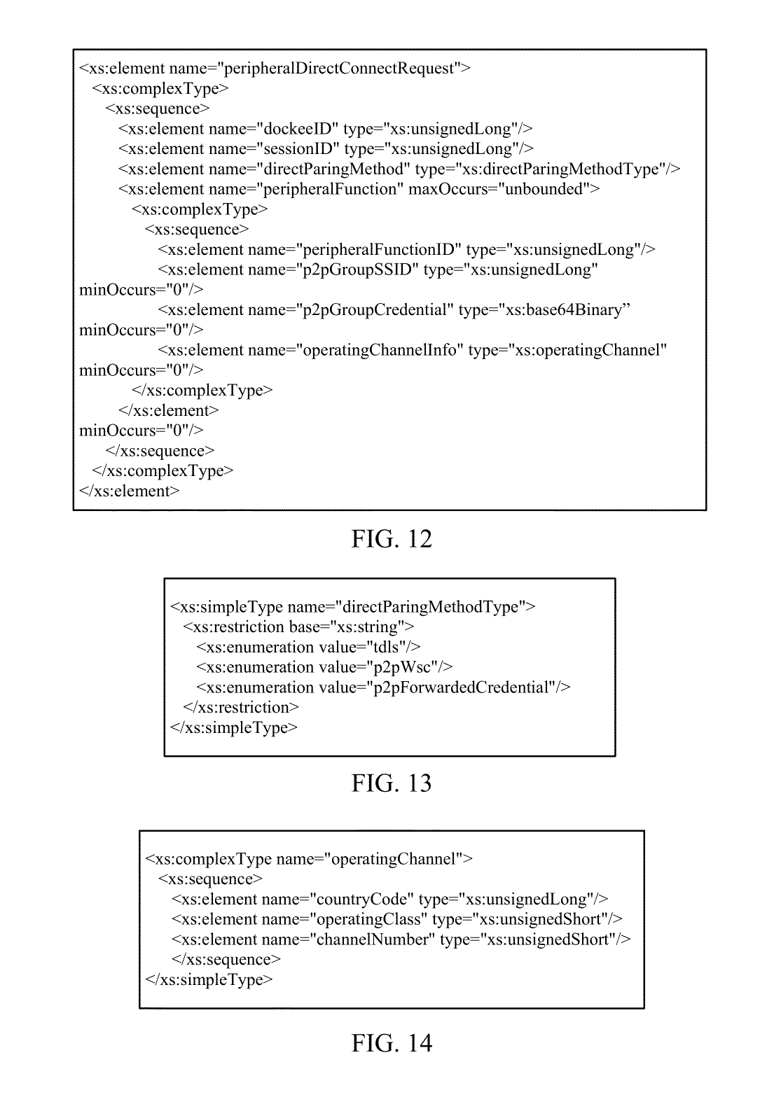

Turning to FIG. 12, a plain text example of a Simple Object Access Protocol (SOAP) body of a Peripheral Direct Connect Request message is depicted according to at least one implementation. In the example shown, the directPairingMethod element may employ the directPairingMethodType depicted in FIG. 13, and the operatingChannelInfo element may employ the operatingChannel depicted in FIG. 14.

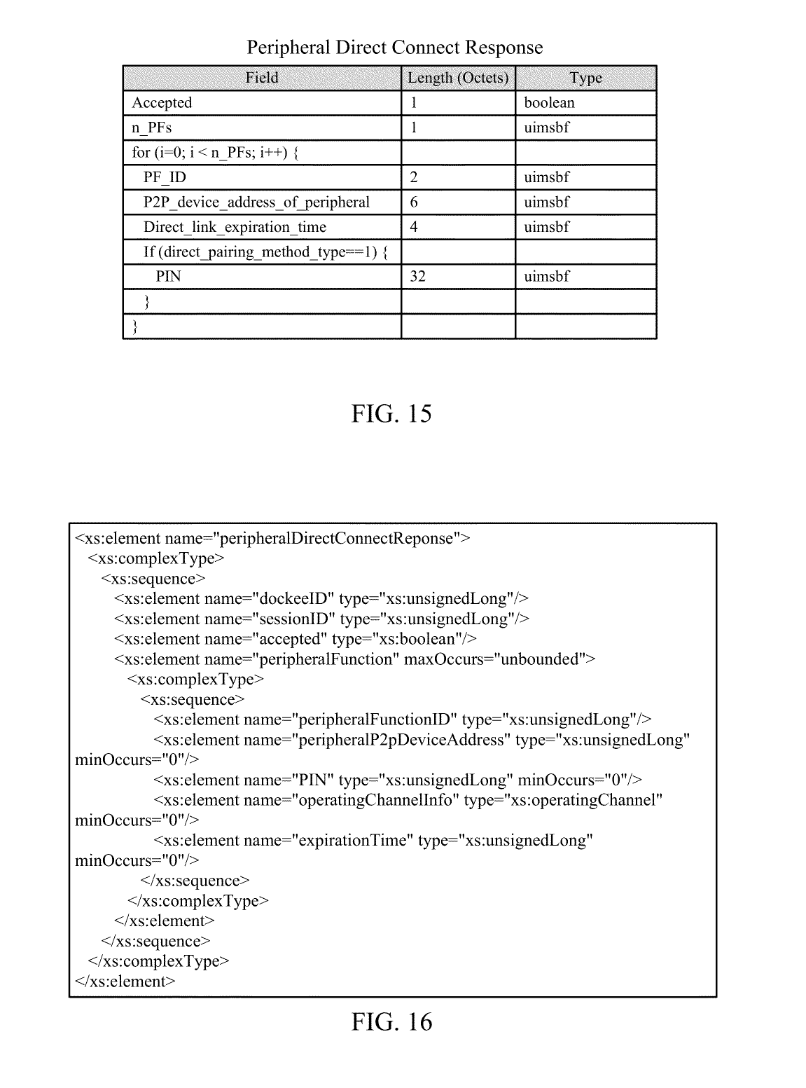

Turning to FIG. 15, an example of at least some fields of a Peripheral Direct Connect Response message are shown according to at least one implementation. This peripheral direct connect response message can be used for all of the peripheral direct connect response messages 508, 612, and 712 in FIGS. 5-7 above. The Peripheral Direct Connect Response message may include an Accepted field adapted to indicate whether the Peripheral Direct Connect Request is acted or not. Further, a P2P_device_address_ofperipheral field may be included, which is adapted to contain the P2P device address of the peripheral 410 which has accepted the request for a direct connection. The PIN field included in the Peripheral Direct Connect Response message can contain the PIN for a WSC procedure if the direct pairing method chosen is P2P with WSC procedure, like the procedure described above with reference to FIG. 6. FIG. 16 is a plain text example of a SOAP body of a Peripheral Direct Connect Response message according to at least one implementation.

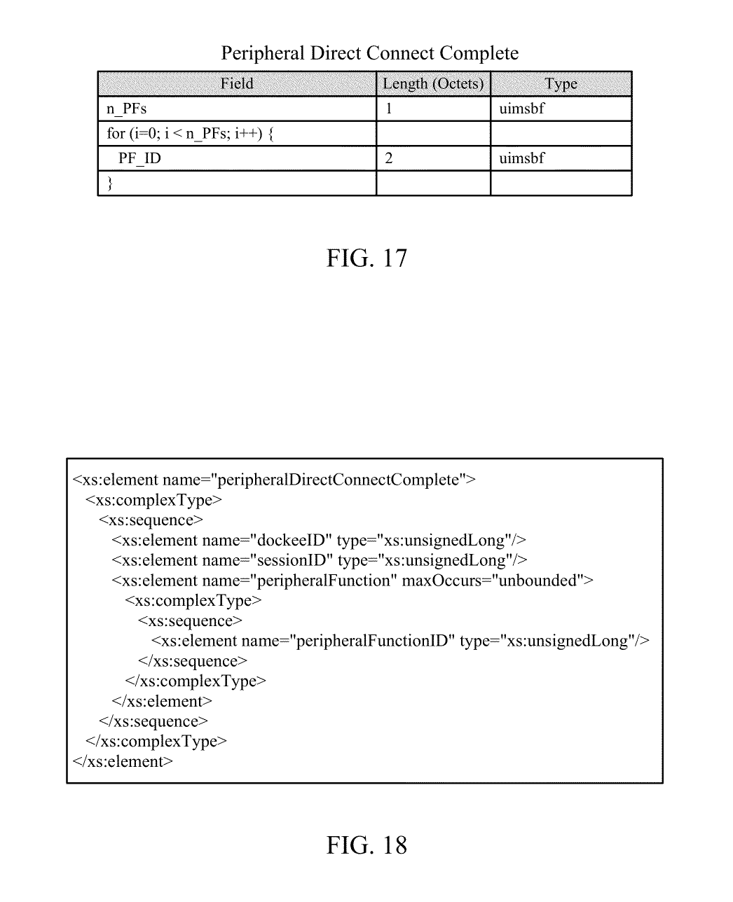

Referring now to FIG. 17, an example of at least some fields of a Peripheral Direct Connect Complete message are shown according to at least one implementation. This peripheral direct connect complete message can be used for all of the peripheral direct connect complete messages 514, 628, and 720 in FIGS. 5-7 above. FIG. 18 is a SOAP body of a Peripheral Direct Connect Complete message according to at least one implementation.

As noted herein above for all the examples described with reference to FIGS. 5-7, the dockee 430 may send a peripheral direct release request message to the docking host 420 to end a direct connection with the peripheral 410. In some instances, the docking host 420 may send a peripheral direct release notification message to the dockee 430 to initiate the termination of the direct communication link between the dockee 430 and the peripheral 410.

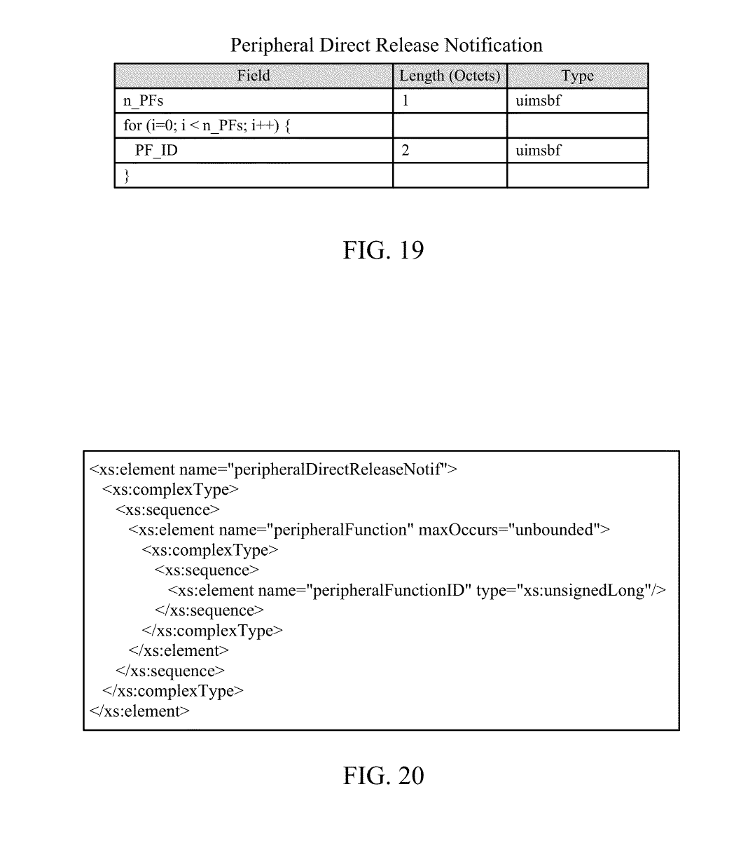

FIG. 19 illustrates an example of at least some of the fields of a Peripheral Direct Release Notification message according to at least one implementation. This peripheral direct release notification message can be used for the peripheral direct release notification message 522 in FIG. 5 above. FIG. 20 is a SOAP body of a Peripheral Direct Release Notification message according to at least one example.

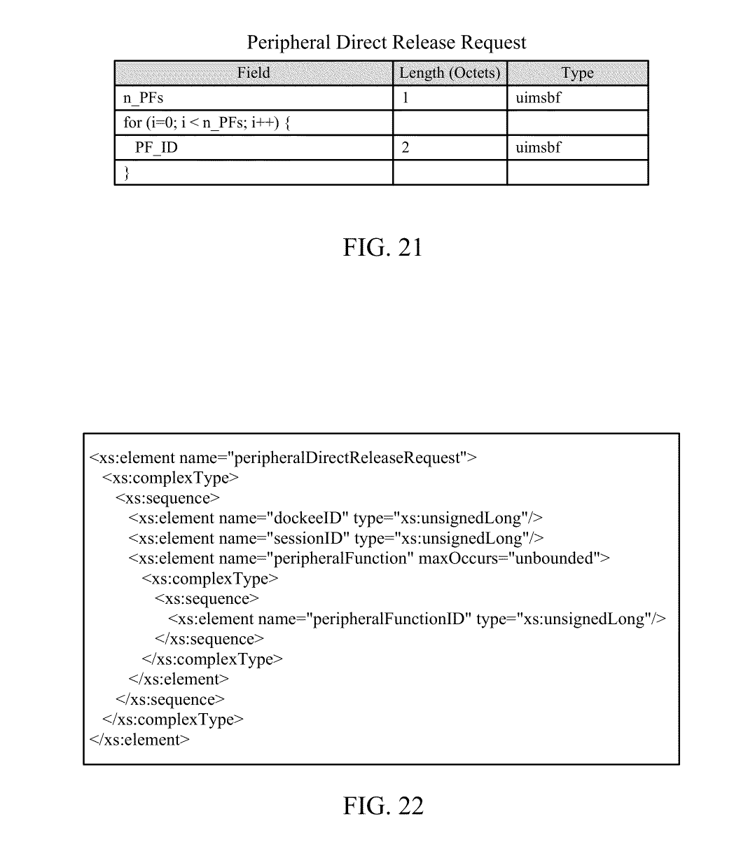

FIG. 21 is an example of at least some of the fields of a Peripheral Direct Release Request message according to at least one implementation. This peripheral direct release request message can be used for the peripheral direct release request message 518 in FIG. 5 above. Further, FIG. 22 is a SOAP body of a Peripheral Direct Release Request message according to at least one example.

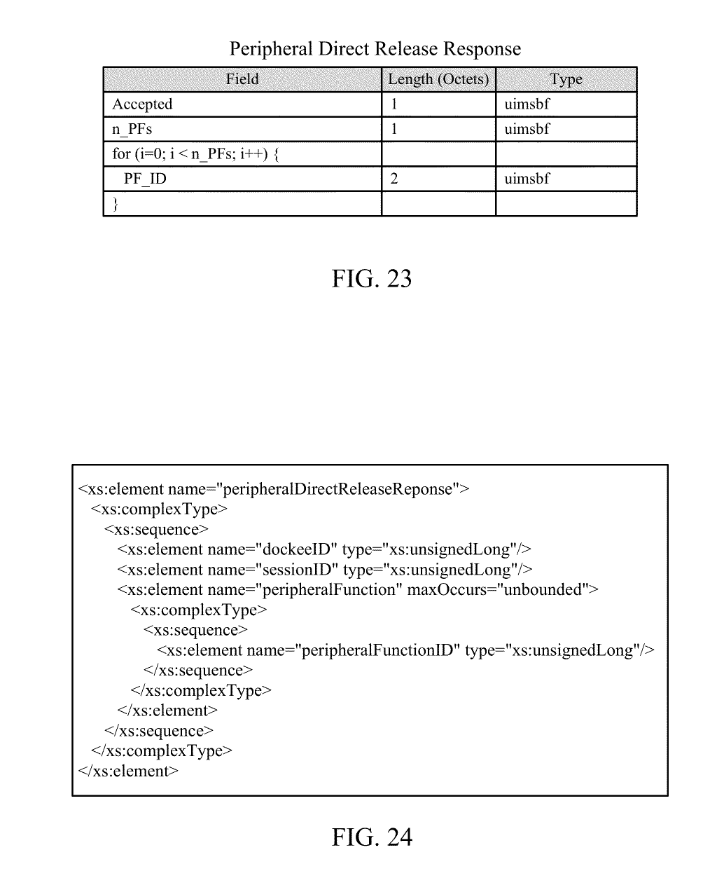

FIG. 23 is an example of at least some of the fields of a Peripheral Direct Release Response message according to at least one implementation. This peripheral direct release response message can be used for the peripheral direct release response message 520 in FIG. 5 above. Further, FIG. 24 is a SOAP body of a Peripheral Direct Release Response message according to at least one example.

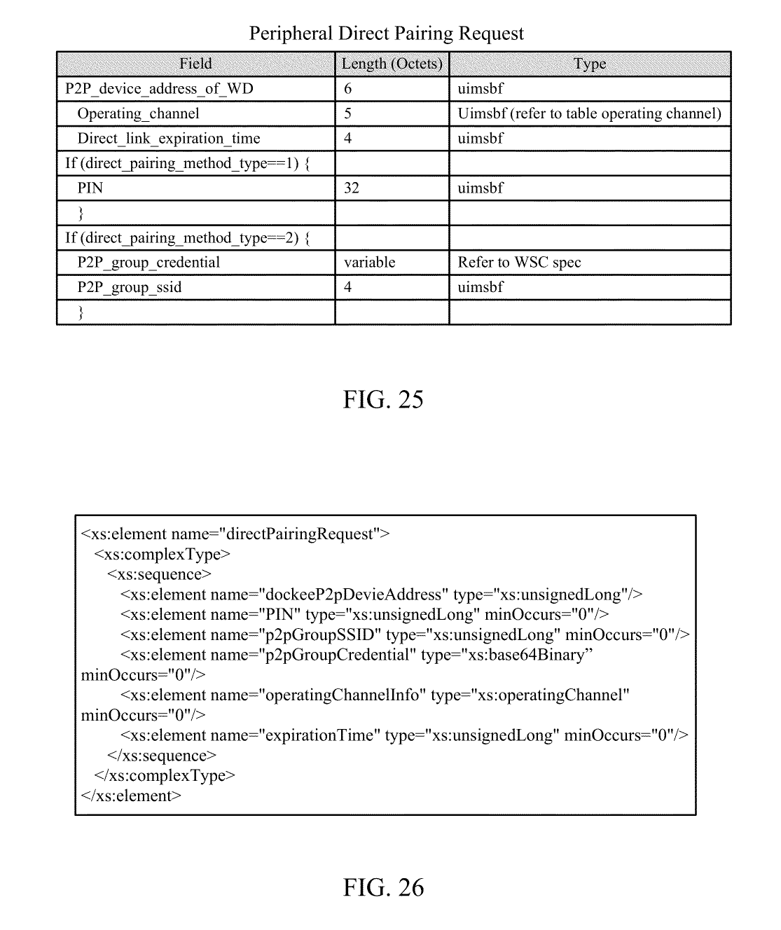

Referring now to FIG. 25, an example of at least some fields of a Peripheral Direct Pairing Request message are shown according to at least one implementation. This peripheral direct pairing request message can be used for all of the peripheral direct pairing request messages 608 and 708 in FIGS. 6 and 7 above. As shown, the Peripheral Direct Pairing Request message can include a P2P_device_address_of WD field. This P2P_device_address_of WD field can include the P2P device address of the dockee 430 that is requesting to direct connect to the peripheral 410. FIG. 26 is a SOAP body of a Peripheral Direct Pairing Request message according to at least one implementation.

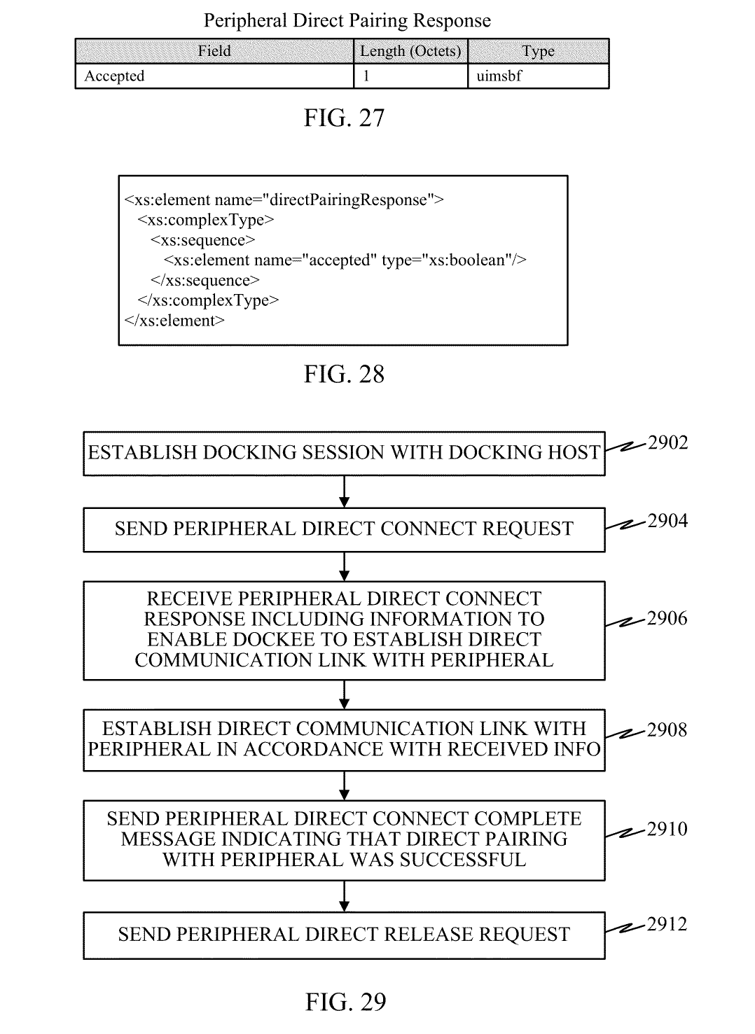

Turning to FIG. 27, an example of at least some fields of a Peripheral Direct Pairing Response message are shown according to at least one implementation. This peripheral direct pairing response message can be used for all of the peripheral direct pairing response messages 610 and 710 in FIGS. 6 and 7 above. FIG. 28 is a SOAP body of a Peripheral Direct Pairing Response message according to at least one implementation.

FIG. 29 is a flow diagram illustrating at least one example of a method operational on a dockee, such as the dockee 430. Referring to FIGS. 4 and 29, a dockee 430 can establish a docking session with a docking host (e.g., docking host 420), at 2902. For example, the processor 432 executing programming stored at the storage medium 436 may establish a communication link 444 via the communication interface 434 with the docking host 420. In some examples, the dockee 430 may connect to the docking host 420 as a P2P client with the docking host 420 configured as the P2P GO. In other examples, the dockee 430 may establish the docking session as the P2P GO with the docking host 420 as a P2P client.

At 2904, the dockee 430 can send a peripheral direct connect request to the docking host 420. For example, the processor 432 may generate and transmit a peripheral direct connect request to the docking host 420 via the communication interface 434. In some examples, the peripheral direct connect request may be formatted like the peripheral direct connect request described above and depicted in FIG. 9, together with corresponding elements depicted in FIGS. 10 and 11. In some examples, the peripheral direct connect request may be transmitted as an xml message configured like the SOAP body depicted in FIG. 12, with the corresponding elements depicted in FIGS. 13 and 14.

As described above, the peripheral direct connect request may include a direct pairing method indicator adapted to indicate the direct pairing method to be employed to directly pair with the peripheral 410. In at least one example, this direct pairing method indicator may indicate one of a tunneled direct link setup (TDLS), a peer-to-peer (P2P) with a Wi-Fi Simple Configuration (WSC) procedure, or a P2P with forwarded group credentials. For instance, in one example where the docking host 420 is the P2P GO and the dockee 430 is a P2P client, the peripheral direct connect request may include a direct pairing method indicator adapted to indicate the direct pairing method as TDLS. In this example, the peripheral direct connect request may also identify an operating channel for direct pairing.

In an example where the dockee 430 is the P2P GO and the docking host 420 is a P2P client, the peripheral direct connect request may include a direct pairing method indicator adapted to indicate the direct pairing method as P2P with a Wi-Fi Simple Configuration (WSC) procedure. Such a peripheral direct connect request may include an indication of an operating channel for direct pairing.

In another example where the dockee 430 is the P2P GO and the docking host 420 is a P2P client, the peripheral direct connect request may include a direct pairing method indicator adapted to indicate the direct pairing method as P2P with forwarded group credentials. In this example, the peripheral direct connect request may include the P2P group SSID and the P2P group credentials associated with a P2P group for which the dockee is a P2P GO. Such a peripheral direct connect request may also identify an operating channel for direct pairing.

At 2906, the dockee 430 may receive a peripheral direct connect response from the docking host 420. For example, the processor 432 may receive the peripheral direct connect response via the communication interface 434. The peripheral direct connect response includes information to enable the dockee 430 to establish a direct communication link (e.g., communication link 446) with the peripheral 410. In some examples, the peripheral direct connect response may be formatted like the peripheral direct connect response described above and depicted in FIG. 15. In some examples, the peripheral direct connect response may be transmitted as an xml message configured like the SOAP body depicted in FIG. 16.

In at least one example, when the indicated direct pairing method is P2P with a WSC procedure, the peripheral direct connect response may include a P2P device address associated with the peripheral, and a PIN for use in the WSC procedure. In such examples, the peripheral direct connect response may also include a direct connection expiration time.

In another example, where the indicated direct pairing method is P2P with forwarded group credentials, the peripheral direct connect response may include the P2P device address associated with the peripheral, and optionally a direct connection expiration time.

At 2908, the dockee 430 may establish a direct communication link 446 with the peripheral 410 in accordance with the received information. For example, the processor 432 may establish via the communication interface 434 a direct communication link 446 with the peripheral according to the designated direct pairing method and using at least some of the information received in the peripheral direct connect response.

At 2910, after the direct communication link 446 is established with the peripheral 410, the dockee 430 may send a peripheral direct connect complete message to the docking host 420. For example, the processor 432 may transmit a peripheral direct connect complete message via the communication interface 434. The peripheral direct connect complete message can indicate to the docking host 420 that direct pairing with the peripheral 410 was successful. In some examples, the peripheral direct connect complete may be formatted like the peripheral direct connect complete described above and depicted in FIG. 17. In some examples, the peripheral direct connect complete may be transmitted as an xml message configured like the SOAP body depicted in FIG. 18.

At 2912, the dockee 430 may send a peripheral direct release request adapted to end the direct pairing between the dockee 430 and the peripheral 410 and facilitate reestablishing a connection between the docking host 420 and the peripheral 410 and dockee 430. For instance, the processor 432 may transmit the peripheral direct release request via the communication interface 434. In some examples, the peripheral direct release request may be sent in response to receiving a peripheral direct release notification, as set forth herein above. In some examples, the peripheral direct release request may be formatted like the peripheral direct release request described above and depicted in FIG. 21. In some examples, the peripheral direct release request may be transmitted as an xml message configured like the SOAP body depicted in FIG. 22.

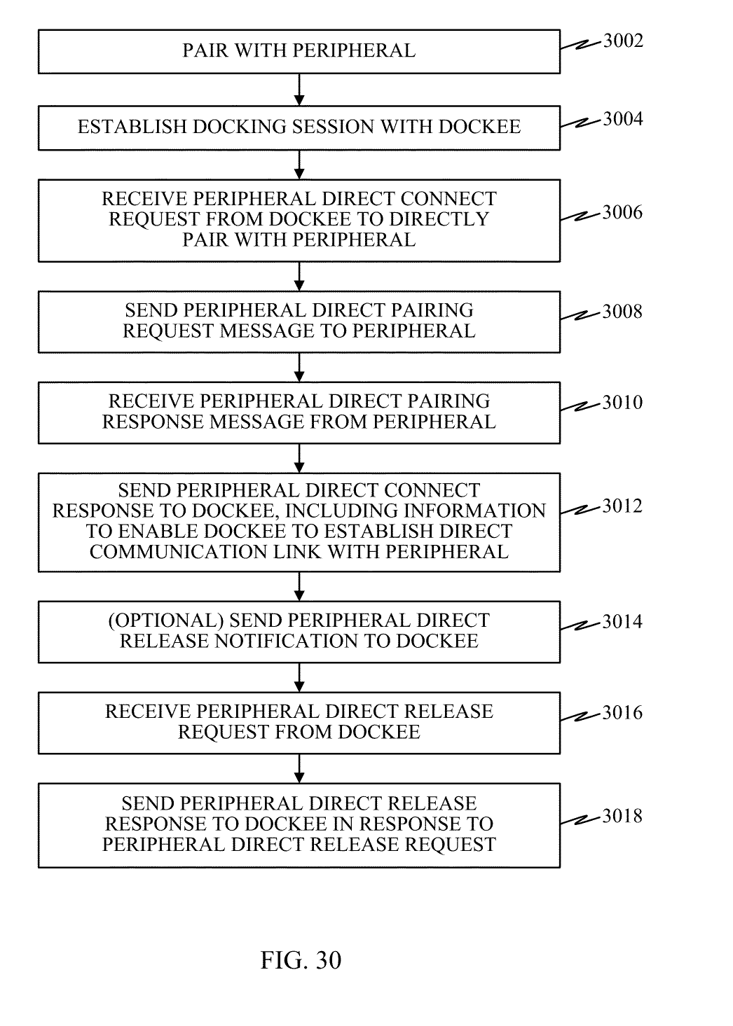

FIG. 30 is a flow diagram illustrating at least one example of a method operational on a docking host, such as the docking host 420. Referring to FIGS. 4 and 30, a docking host 420 can pair with a peripheral 410 at 3002. For example, the processor 422 may pair with a peripheral 410 to establish a communication link 442. The docking host 420 may pair with the peripheral 410 as a P2P GO, with the peripheral as a P2P client.

At 3004, the docking host 420 can establish a docking session with a dockee 430. For example, the processor 422 may establish a docking session with the dockee 430 in which a communication link 444 is established between the two entities. In some instances, the docking host 420 may establish the docking session as a P2P GO with the dockee 430 connected as a P2P client. In other instances, the docking host 420 may establish the docking session as a P2P client of the dockee 430, where the dockee 430 is configured as a P2P GO.

At 3006, the docking host 420 may receive a peripheral direct connect request from the dockee 430 requesting to directly pair with the peripheral 410. For example, the processor 422 may receive the peripheral direct connect request via the communication interface 424. In some examples, the peripheral direct connect request may be formatted like the peripheral direct connect request described above and depicted in FIG. 9, together with corresponding elements depicted in FIGS. 10 and 11. In some examples, the peripheral direct connect request may be received as an xml message configured like the SOAP body depicted in FIG. 12, with the corresponding elements depicted in FIGS. 13 and 14.

As described above, the peripheral direct connect request may include a direct pairing method indicator adapted to indicate the direct pairing method to be employed to directly pair the dockee 430 with the peripheral 410. In at least one example, this direct pairing method indicator may indicate one of a tunneled direct link setup (TDLS), a peer-to-peer (P2P) with a Wi-Fi Simple Configuration (WSC) procedure, or a P2P with forwarded group credentials. For instance, in one example where the docking host 420 is the P2P GO and the dockee 430 is a P2P client, the peripheral direct connect request may include a direct pairing method indicator adapted to indicate the direct pairing method as TDLS. In this example, the peripheral direct connect request may also identify an operating channel for direct pairing.

In an example where the dockee 430 is the P2P GO and the docking host 420 is a P2P client, the peripheral direct connect request may include a direct pairing method indicator adapted to indicate the direct pairing method as P2P with a Wi-Fi Simple Configuration (WSC) procedure. Such a peripheral direct connect request may include an indication of an operating channel for direct pairing.

In another example where the dockee 430 is the P2P GO and the docking host 420 is a P2P client, the peripheral direct connect request may include a direct pairing method indicator adapted to indicate the direct pairing method as P2P with forwarded group credentials. In this example, the peripheral direct connect request may include the P2P group SSID and the P2P group credentials associated with a P2P group for which the dockee is a P2P GO. Such a peripheral direct connect request may also identify an operating channel for direct pairing.

At 3008, the docking host 420 may send a peripheral direct pairing request message to the peripheral 410. For example, the processor 422 may transmit the peripheral direct pairing request message via the communication interface 424. In some examples, the peripheral direct pairing request message may be formatted like the peripheral direct pairing request described above and depicted in FIG. 25. In some examples, the peripheral direct pairing request may be transmitted as an xml message configured like the SOAP body depicted in FIG. 26.

The peripheral direct pairing request may identify the direct pairing method to be used. In examples where the direct pairing method indicates P2P with a WSC procedure, the peripheral direct pairing request may include a P2P device address associated with the dockee 430, and a PIN for use in the PIN-based WSC procedure. In other examples where the direct pairing method indicates P2P with forwarded group credentials, the peripheral direct pairing request may include a P2P device address associated with the dockee, the P2P group SSID, and the P2P group credentials. In either example, the peripheral direct pairing request may also optionally include an operating channel for direct pairing and/or a direct link expiration time.

At 3010, the docking host 420 may receive a peripheral direct pairing response from the peripheral 410. For instance, the processor 422 may receive the peripheral direct pairing response via the communication interface 424. In some examples, the peripheral direct pairing response may be formatted like the peripheral direct pairing response described above and depicted in FIG. 27. In some examples, the peripheral direct pairing response may be received as an xml message configured like the SOAP body depicted in FIG. 28.

At 3012, the docking host 420 may send a peripheral direct connect response to the dockee 430. For example, the processor 422 may transmit the peripheral direct connect response via the communication interface 424. In some examples, the peripheral direct connect response may be formatted like the peripheral direct connect response described above and depicted in FIG. 15. In some examples, the peripheral direct connect response may be transmitted as an xml message configured like the SOAP body depicted in FIG. 16.

The peripheral direct connect response generally includes information to enable the dockee 430 to establish a direct communication link with the peripheral 410. For example, when the direct pairing method is identified as P2P with a WSC procedure, the peripheral direct connect response may include a P2P device address associated with the peripheral and a PIN for use in the WSC procedure. When the direct pairing method is identified as P2P with forwarded group credentials, the peripheral direct connect response may include the P2P device address associated with the peripheral. In either example, the peripheral direct connect response may further include an optional direct connection expiration time.

In some instances, the docking host 420 may, at 3014, optionally send a peripheral direct release notification to the dockee 430 to end the direct communication link between the dockee 430 and the peripheral 410. For example, the processor 422 may generate and transmit a peripheral direct release notification via the communication interface 424. In some examples, the peripheral direct release notification may be formatted like the peripheral direct release notification described above and depicted in FIG. 19. In some examples, the peripheral direct release notification may be transmitted as an xml message configured like the SOAP body depicted in FIG. 20.

Either in response to a peripheral direct release notification, or on initiative of the dockee 430, the docking host 420 may receive a peripheral direct release request from the dockee 430 at 3016. For example, the processor 422 may receive the peripheral direct release request from the dockee 430 via the communication interface 424. In some examples, the peripheral direct release request may be formatted like the peripheral direct release request described above and depicted in FIG. 21. In some examples, the peripheral direct release request may be received as an xml message configured like the SOAP body depicted in FIG. 22.

In response to the peripheral direct release request, the docking host 420 may send a peripheral direct release response to the dockee at 3018. For example, the processor 422 may transmit the peripheral direct release response to the dockee 430 via the communication interface 424. In some examples, the peripheral direct release response may be formatted like the peripheral direct release request described above and depicted in FIG. 23. In some examples, the peripheral direct release response may be transmitted as an xml message configured like the SOAP body depicted in FIG. 24.

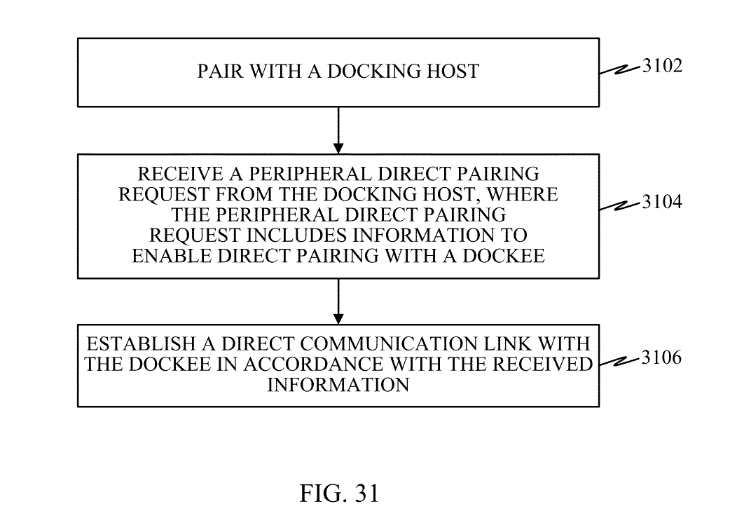

FIG. 31 is a flow diagram illustrating at least one example of a method operational on a peripheral, such as the peripheral 410. Referring to FIGS. 4 and 31, a peripheral 410 can pair with a docking host at 3102. For example, the processor 412 may pair with a docking host 420 to establish a communication link 442. The peripheral 410 may pair with the docking host 420 as a client of docking host 420 configured as a P2P GO.

At 3104, the peripheral 410 may receive a peripheral direct pairing request from the docking host 420. For example,

For example, the processor 412 may receive the peripheral direct pairing request via the communication interface 416. In some examples, the peripheral direct pairing request message may be formatted like the peripheral direct pairing request described above and depicted in FIG. 25. In some examples, the peripheral direct pairing request may be received as an xml message configured like the SOAP body depicted in FIG. 26.

The peripheral direct pairing request may identify the direct pairing method to be used, and may include relevant information to enable direct pairing with a dockee 430. In examples where the direct pairing method indicates P2P with a WSC procedure, the peripheral direct pairing request may include a P2P device address associated with the dockee 430, and a PIN for use in the PIN-based WSC procedure. In other examples where the direct pairing method indicates P2P with forwarded group credentials, the peripheral direct pairing request may include a P2P device address associated with the dockee, the P2P group SSID, and the P2P group credentials. In either example, the peripheral direct pairing request may also optionally include an operating channel for direct pairing and/or a direct link expiration time.

At 3106, the peripheral 410 may establish a direct communication link 446 with the dockee 430 in accordance with the received information. For example, the processor 412 may establish via the communication interface 416 a direct communication link 446 with the dockee 430 according to the designated direct pairing method and using at least some of the information received in the peripheral direct pairing request.

While the above discussed aspects, arrangements, and embodiments are discussed with specific details and particularity, one or more of the components, steps, features and/or functions illustrated in FIGS. 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, and/or 31 may be rearranged and/or combined into a single component, step, feature or function or embodied in several components, steps, or functions. Additional elements, components, steps, and/or functions may also be added or not utilized without departing from the present disclosure. The apparatus, devices and/or components illustrated in FIGS. 1, 2, 3, and/or 4 may be configured to perform or employ one or more of the methods, features, parameters, messages, and/or steps described in FIGS. 5, 6, 7, 8, 9, 10, 11, 12, 13, 14, 15, 16, 17, 18, 19, 20, 21, 22, 23, 24, 25, 26, 27, 28, 29, 30, and/or 31. The novel algorithms described herein may also be efficiently implemented in software and/or embedded in hardware.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

What is claimed is:

1. A dockee, comprising:
a communication interface;
a storage medium; and
at least one processor coupled to the communication interface and the storage medium, the at least one processor adapted to:
establish a docking session with a docking host;
transmit, via the communication interface, a peripheral direct connect request to the docking host;
receive, via the communication interface, a peripheral direct connect response from the docking host, wherein the peripheral direct connect response includes information to enable the dockee to directly pair with a peripheral; and
establish a direct communication link with a peripheral in accordance with the received information.

2. The dockee of claim 1, wherein the peripheral direct connect request comprises a direct pairing method indicator adapted to indicate a direct pairing method to be employed to directly pair with the peripheral, wherein the indicated direct pairing method is selected from a group of direct pairing methods comprising tunneled direct link setup (TDLS), peer-to-peer (P2P) with a Wi-Fi Simple Configuration (WSC) procedure, and P2P with forwarded group credentials.

3. The dockee of claim 1, wherein:
the peripheral direct connect request comprises a direct pairing method indicator adapted to indicate the direct pairing method as P2P with forwarded group credentials, and a P2P group SSID and P2P group credentials associated with a P2P group for which the dockee is a group owner (GO); and
the received peripheral direct connect response comprises a P2P device address associated with the peripheral.

4. The dockee of claim 1, wherein:
the peripheral direct connect request comprises a direct pairing method indicator adapted to indicate the direct pairing method as P2P with a Wi-Fi Simple Configuration (WSC) procedure; and
the received peripheral direct connect response comprises a P2P device address associated with the peripheral, and a PIN for use in the WSC procedure.

5. The dockee of claim 1, wherein the at least one processor is further adapted to:
transmit, via the communication interface, a peripheral direct connect complete message from the dockee indicating that the dockee has successfully paired directly with the peripheral.

6. The dockee of claim 1, wherein the at least one processor is further adapted to:
receive, via the communication interface, a peripheral direct release notification from the docking host; and
in response to the peripheral direct release notification, transmit via the communication interface a peripheral direct release request to end the direct communication link with the peripheral.

7. A method operational at a dockee, comprising:
establishing a docking session with a docking host;
sending a peripheral direct connect request to the docking host;
receiving a peripheral direct connect response from the docking host, wherein the peripheral direct connect response includes information to enable the dockee to directly pair with a peripheral; and
establishing a direct communication link with a peripheral in accordance with the received information.

8. The method of claim 7, wherein establishing the docking session with the docking host comprises:
establishing the docking session as a peer-to-peer (P2P) client of the docking host, wherein the docking host is configured as a P2P group owner (GO).

9. The method of claim 8, wherein sending the peripheral direct connect request to the docking host comprises:
sending the peripheral direct connect request comprising a direct pairing method indicator adapted to indicate the direct pairing method as tunneled direct link setup (TDLS).

10. The method of claim 7, wherein establishing the docking session with the docking host comprises:
establishing the docking session as a peer-to-peer (P2P) group owner (GO) with the docking host as a P2P client.

11. The method of claim 10, wherein:
sending the peripheral direct connect request to the docking host comprises sending the peripheral direct connect request comprising a direct pairing method indicator adapted to indicate the direct pairing method as P2P with a Wi-Fi Simple Configuration (WSC) procedure; and
receiving the peripheral direct connect response from the docking host comprises receiving the peripheral direct connect response comprising a P2P device address associated with the peripheral, and a PIN for use in the WSC procedure.

12. The method of claim 10, wherein:
sending the peripheral direct connect request to the docking host comprises sending the peripheral direct connect request comprising a direct pairing method indicator adapted to indicate the direct pairing method as P2P with forwarded group credentials, and a P2P group SSID and P2P group credentials associated with a P2P group for which the dockee is a group owner (GO); and
receiving the peripheral direct connect response from the docking host comprises receiving the peripheral direct connect response comprising a P2P device address associated with the peripheral.

13. The method of claim 7, further comprising:
sending a peripheral direct connect complete message from the dockee indicating that the dockee has successfully paired directly with the peripheral.

14. The method of claim 7, further comprising:
sending a peripheral direct release request to end the direct communication link with the peripheral.

15. A dockee, comprising:
means for establishing a docking session with a docking host;
means for transmitting a peripheral direct connect request to the docking host;
means for receiving a peripheral direct connect response from the docking host, wherein the peripheral direct connect response includes information to enable the dockee to directly pair with a peripheral; and
means for establishing a direct communication link with a peripheral in accordance with the received information.

16. The dockee of claim 15, wherein the peripheral direct connect request comprises a direct pairing method indicator adapted to indicate a direct pairing method to be employed to directly pair with the peripheral, wherein the indicated direct pairing method is selected from a group of direct pairing methods comprising tunneled direct link setup (TDLS), peer-to-peer (P2P) with a Wi-Fi Simple Configuration (WSC) procedure, and P2P with forwarded group credentials.

17. The dockee of claim 15, further comprising:
means for transmitting a peripheral direct connect complete message from the dockee indicating that the dockee has successfully paired directly with the peripheral.

18. The dockee of claim 15, further comprising:
means for transmitting a peripheral direct release request to end the direct communication link with the peripheral.

19. A computer-readable storage medium, comprising programming for causing a computer to:
establish a docking session with a docking host;
transmit a peripheral direct connect request to the docking host;
receive a peripheral direct connect response from the docking host, wherein the peripheral direct connect response includes information to enable the dockee to directly pair with a peripheral; and
establish a direct communication link with a peripheral in accordance with the received information.

20. The computer-readable storage medium of claim 19, wherein the peripheral direct connect request comprises a direct pairing method indicator adapted to indicate a direct pairing method to be employed to directly pair with the peripheral, wherein the indicated direct pairing method is selected from a group of direct pairing methods comprising tunneled direct link setup (TDLS), peer-to-peer (P2P) with a Wi-Fi Simple Configuration (WSC) procedure, and P2P with forwarded group credentials.

21. The computer-readable storage medium of claim 19, further comprising programming for causing a computer to:
send a peripheral direct connect complete message from the dockee indicating that the dockee has successfully paired directly with the peripheral.

22. The computer-readable storage medium of claim 19, further comprising programming for causing a computer to:
send a peripheral direct release request to end the direct communication link with the peripheral.

23. A docking host, comprising:
a communication interface;
a storage medium; and
at least one processor coupled to the communication interface and the storage medium, the at least one processor adapted to:
pair with a peripheral;
establish a docking session with a dockee;
receive, via the communication interface, a peripheral direct connect request from the dockee to directly pair with the peripheral; and
transmit, via the communication interface, a peripheral direct connect response to the dockee, wherein the peripheral direct connect response includes information to enable the dockee to directly pair with the peripheral.

24. The docking host of claim 23, wherein the peripheral direct connect request received from the dockee comprises a direct pairing method indicator adapted to indicate a direct pairing method to be employed to directly pair with the peripheral, wherein the indicated direct pairing method is selected from a group of direct pairing methods comprising tunneled direct link setup (TDLS), peer-to-peer (P2P) with a Wi-Fi Simple Configuration (WSC) procedure, and P2P with forwarded group credentials.

25. The docking host of claim 24, wherein the peripheral direct connect request received from the dockee includes:
the direct pairing method indicator adapted to indicate the direct pairing method as P2P with forwarded group credentials;
a P2P group SSID associated with a P2P group for which the dockee is a group owner (GO); and
P2P group credentials associated with the P2P group.

26. The docking host of claim 23, wherein the at least one processor is further adapted to:
transmit, via the communication interface, a peripheral direct pairing request message to the peripheral; and
receive, via the communication interface, a peripheral direct pairing response message from the peripheral.

27. The docking host of claim 26, wherein:
the peripheral direct pairing request message comprises a peer-to-peer (P2P) device address associated with the dockee, and a PIN for use in direct pairing method comprising a PIN-based Wi-Fi Simple Configuration (WSC) procedure; and
the peripheral direct connect response message comprises a P2P device address associated with the peripheral, and the PIN for use in the PIN-based WSC procedure.

28. The docking host of claim 26, wherein:
the peripheral direct pairing request message comprises a peer-to-peer (P2P) device address associated with the dockee, and a P2P group SSID and P2P group credentials associated with a P2P group for which the dockee is a group owner (GO); and
the peripheral direct connect response message comprises a P2P device address associated with the peripheral.

29. The docking host of claim 23, wherein the at least one processor is further adapted to:
receive, via the communication interface, a peripheral direct connect complete message from the dockee, wherein the peripheral direct connect complete message is adapted to indicate that the dockee has directly paired to the peripheral.

30. The docking host of claim 23, wherein the at least one processor is further adapted to:
transmit, via the communication interface, a peripheral direct release notification to the dockee to initiate an end to a direct pairing between the dockee and the peripheral;
receive, via the communication interface, a peripheral direct release request from the dockee; and
send a peripheral direct release response to the dockee in response to the received peripheral direct release request.

31. A method operational on a docking host, comprising:
pairing with a peripheral;
establishing a docking session with a dockee;
receiving a peripheral direct connect request from the dockee to directly pair with the peripheral; and
sending a peripheral direct connect response to the dockee, wherein the peripheral direct connect response includes information to enable the dockee to establish a direct communication link with the peripheral.

32. The method of claim 31, wherein pairing with the peripheral comprises:
pair with the peripheral as a peer-to-peer (P2P) group owner (GO), with the peripheral as a P2P client.

33. The method of claim 31, wherein establishing the docking session with the dockee comprises:
establishing the docking session as a peer-to-peer (P2P) group owner (GO) with the dockee as a P2P client.

34. The method of claim 33, wherein receiving the peripheral direct connect request from the dockee comprises:
receiving the peripheral direct connect request comprising a direct pairing method indicator adapted to indicate the direct pairing method as tunneled direct link setup (TDLS).

35. The method of claim 31, wherein establishing the docking session with the dockee comprises:
establishing the docking session as a peer-to-peer (P2P) client of the dockee, wherein the dockee is configured as a P2P group owner (GO).

36. The method of claim 35, wherein receiving the peripheral direct connect request from the dockee comprises:
receiving the peripheral direct connect request comprising a direct pairing method indicator adapted to indicate the direct pairing method as P2P with a Wi-Fi Simple Configuration (WSC) procedure.

37. The method of claim 36, further comprising:
sending a peripheral direct pairing request message to the peripheral, the peripheral direct pairing request message comprising a P2P device address associated with the dockee, and a PIN for use in the WSC procedure; and
wherein sending the peripheral direct connect response to the dockee comprises sending to the dockee a P2P device address associated with the peripheral, and the PIN for use in the WSC procedure.

38. The method of claim 35, wherein receiving the peripheral direct connect request from the dockee comprises:
receiving the peripheral direct connect request comprising:
a direct pairing method indicator adapted to indicate the direct pairing method as P2P with forwarded group credentials;
a P2P group SSID associated with a P2P group for which the dockee is a group owner (GO); and
P2P group credentials associated with the P2P group for which the dockee is the GO.

39. The method of claim 38, further comprising:
sending a peripheral direct pairing request message to the peripheral, the peripheral direct pairing request message comprising a P2P device address associated with the dockee, the P2P group SSID, and the P2P group credentials; and
wherein sending the peripheral direct connect response to the dockee comprises sending to the dockee a P2P device address associated with the peripheral.

40. The method of claim 31, further comprising:
receiving a peripheral direct connect complete message from the dockee indicating that the dockee has successfully paired directly with the peripheral.

41. The method of claim 31, further comprising:
receiving a peripheral direct release request from the dockee to request that a direct pairing between the dockee and the peripheral be ended; and
sending a peripheral direct release response to the dockee in response to the received peripheral direct release request.

42. A docking host, comprising:
means for pairing with a peripheral;
means for establishing a docking session with a dockee;
means for receiving a peripheral direct connect request from the dockee to directly pair with the peripheral; and
means for transmitting a peripheral direct connect response to the dockee, wherein the response includes information to enable the dockee to establish a direct communication link with the peripheral.

43. The docking host of claim 42, wherein the peripheral direct connect request comprises a direct pairing method indicator adapted to indicate a direct pairing method to be employed by the dockee to directly pair with the peripheral, wherein the indicated direct pairing method is selected from a group of direct pairing methods comprising tunneled direct link setup (TDLS), peer-to-peer (P2P) with a Wi-Fi Simple Configuration (WSC) procedure, and P2P with forwarded group credentials.

44. The docking host of claim 43, wherein the received peripheral direct connect request includes:
the direct pairing method indicator adapted to indicate the direct pairing method as P2P with forwarded group credentials;
a P2P group SSID associated with a P2P group for which the dockee is a group owner (GO); and
P2P group credentials associated with the P2P group.

45. The docking host of claim 42, further comprising:
means for transmitting a peripheral direct pairing request message to the peripheral; and
means for receiving a peripheral direct pairing response message from the peripheral.

46. The docking host of claim 45, wherein:
the peripheral direct pairing request message comprises a peer-to-peer (P2P) device address associated with the dockee, and a PIN for use in direct pairing method comprising a PIN-based Wi-Fi Simple Configuration (WSC) procedure; and
the peripheral direct connect response message comprises a P2P device address associated with the peripheral, and the PIN for use in the PIN-based WSC procedure.

47. The docking host of claim 45, wherein:
the peripheral direct pairing request message comprises a peer-to-peer (P2P) device address associated with the dockee, and a P2P group SSID and P2P group credentials associated with a P2P group for which the dockee is a group owner (GO); and
the peripheral direct connect response message comprises a P2P device address associated with the peripheral.

48. A computer-readable storage medium, comprising programming for causing a computer to:
pair with a peripheral;
establish a docking session with a dockee;
receive a peripheral direct connect request from the dockee to directly pair with the peripheral; and
send a peripheral direct connect response to the dockee, wherein the response includes information to enable the dockee to establish a direct communication link with the peripheral.

49. The computer-readable storage medium of claim 48, wherein the peripheral direct connect request comprises a direct pairing method indicator adapted to indicate a direct pairing method to be employed by the dockee to directly pair with the peripheral, and wherein the indicated direct pairing method is selected from a group of direct pairing methods comprising tunneled direct link setup (TDLS), peer-to-peer (P2P) with a Wi-Fi Simple Configuration (WSC) procedure, and P2P with forwarded group credentials.

50. The computer-readable storage medium of claim 49, wherein the received peripheral direct connect request includes:
the direct pairing method indicator adapted to indicate the direct pairing method as P2P with forwarded group credentials;
a P2P group SSID associated with a P2P group for which the dockee is a group owner (GO); and
P2P group credentials associated with the P2P group.

51. The computer-readable storage medium of claim 48, further comprising programming for causing a computer to:
send a peripheral direct pairing request message to the peripheral, wherein the peripheral direct pairing request message includes information to enable the peripheral to establish a direct communication link with the dockee; and
receive a peripheral direct pairing response message from the peripheral.

52. The computer-readable storage medium of claim 48, further comprising programming for causing a computer to:
receive a peripheral direct connect complete message from the dockee indicating that the dockee has successfully paired directly with the peripheral.

53. The computer-readable storage medium of claim 48, further comprising programming for causing a computer to:
receive a peripheral direct release request from the dockee to request that a direct pairing between the dockee and the peripheral be ended; and
send a peripheral direct release response to the dockee in response to the received peripheral direct release request.

54. A peripheral, comprising:
a communication interface;
a storage medium; and
at least one processor coupled to the communication interface and the storage medium, the at least one processor adapted to:
pair with a docking host;
receive a peripheral direct pairing request from the docking host, wherein the peripheral direct pairing request includes information to enable direct pairing with a dockee; and
establish a direct communication link with the dockee in accordance with the received information.

55. The peripheral of claim 54, wherein the peripheral direct pairing request received from the docking host comprises:
a peer-to-peer (P2P) device address associated with the dockee; and
a PIN for use in a direct pairing method comprising a PIN-based Wi-Fi Simple Configuration (WSC) procedure.

56. The peripheral of claim 54, wherein the peripheral direct pairing request received from the docking host comprises:
a peer-to-peer (P2P) device address associated with the dockee;
a P2P group SSID associated with a P2P group for which the dockee is a group owner (GO); and
a P2P group credentials associated with the P2P group for which the dockee is the GO.

57. A method operational at a peripheral, comprising:
pairing with a docking host;
receiving a peripheral direct pairing request from the docking host, wherein the peripheral direct pairing request includes information to enable direct pairing with a dockee; and
establishing a direct communication link with the dockee in accordance with the received information.

58. The method of claim 57, wherein receiving the peripheral direct pairing request from the docking host comprises:
receiving the peripheral direct pairing request comprising a peer-to-peer (P2P) device address associated with the dockee, and a PIN for use in a direct pairing method comprising a PIN-based Wi-Fi Simple Configuration (WSC) procedure.

59. The method of claim 57, wherein receiving the peripheral direct pairing request from the docking host comprises:
receiving the peripheral direct pairing request comprising a peer-to-peer (P2P) device address associated with the dockee, and a P2P group SSID and P2P group credentials associated with a P2P group for which the dockee is a group owner (GO).

60. A peripheral, comprising:
means for pairing with a docking host;
means for receiving a peripheral direct pairing request from the docking host, wherein the peripheral direct pairing request includes information to enable direct pairing with a dockee; and
means for establishing a direct communication link with the dockee in accordance with the received information.

61. The peripheral of claim 60, wherein the peripheral direct pairing request received from the docking host comprises:
a peer-to-peer (P2P) device address associated with the dockee; and
a PIN for use in a direct pairing method comprising a PIN-based Wi-Fi Simple Configuration (WSC) procedure.

62. The peripheral of claim 60, wherein the peripheral direct pairing request received from the docking host comprises:
a peer-to-peer (P2P) device address associated with the dockee;
a P2P group SSID associated with a P2P group for which the dockee is a group owner (GO); and
a P2P group credentials associated with the P2P group for which the dockee is the GO.

63. A computer-readable storage medium, comprising programming for causing a computer to:
pair with a docking host;
receive a peripheral direct pairing request from the docking host, wherein the peripheral direct pairing request includes information to enable direct pairing with a dockee; and
establish a direct communication link with the dockee in accordance with the received information.

64. The computer-readable storage medium of claim 63, wherein the peripheral direct pairing request received from the docking host comprises:
a peer-to-peer (P2P) device address associated with the dockee; and
a PIN for use in a direct pairing method comprising a PIN-based Wi-Fi Simple Configuration (WSC) procedure.

65. The computer-readable storage medium of claim 63, wherein the peripheral direct pairing request received from the docking host comprises:
a peer-to-peer (P2P) device address associated with the dockee;
a P2P group SSID associated with a P2P group for which the dockee is a group owner (GO); and
a P2P group credentials associated with the P2P group for which the dockee is the GO.
